(19) United States
(12) Patent Application Publication
(10) Pub. No.: US 2020/0410791 A1
(43) Pub. Date: Dec. 31, 2020

(54) SITE SUPERVISOR SYSTEM FOR CONSTRUCTION SITES

(71) Applicant: Scientia Potentia Est, LLC., Charleston, SC (US)

(72) Inventors: Jeremy Blackburn, Charleston, SC (US); Tim McVicker, Charleston, SC (US); Justin Southward, Charleston, SC (US); W. Kurt Taylor, N. Charleston, SC (US); Karl David, Charleston, SC (US); Austi Critchfield, Clearwater, FL (US)

(21) Appl. No.: 16/452,076

(22) Filed: Jun. 25, 2019

(51) Int. Cl. G07C 9/00; G06K 9/00; H04W 4/80

(52) U.S. Cl. CPC G07C 9/00087; G07C 9/00111; G06K 9/00295; G07C 2009/00095; G06K 9/00362; H04W 4/80; G06K 9/00771

(57) ABSTRACT

Exemplary embodiments may provide a site supervisor system for providing security and controlling access to a construction site. The site supervisor system may monitor and record information regarding individuals entering and leaving the construction site. The site supervisor system may also monitor the perimeter of the construction site to provide security, especially during non-working hours. The site supervisor system may use biometric-based identification devices to confirm the identity of individuals entering or leaving the construction site. In addition, the biometric-based identification devices may also be used to identify individuals on the perimeter of the construction site. The site supervisor system may also control access to tools, equipment, materials and areas of the construction site. As to tools, equipment and materials, the site supervisor system may confirm the identity of an individual and grant access to certain tools and equipment using smart locks and/or other technology. The site supervisor system may limit the dates and duration of access to the tools/equipment such that the tools/equipment must be returned within the specified date/time window.

### BACKGROUND

Control and accountability at a construction site affect efficiency, productivity, and ultimately costs and profitability. Security, access control, automated process management, secure, centralized real time records and data, and accountability at construction sites are often lacking or lax.

In many instances, individuals may come and go from construction sites freely. Moreover, there often are no security mechanisms for protecting the construction sites after hours. Access to a given construction site is typically controlled by the presence of supervisors at the site. Unfortunately, such supervisors may find it difficult to monitor and control access of all of the individuals coming and leaving from the construction site, and any one supervisor is not present on the site twenty-four hours a day, seven days a week. With a human supervisor, there is not a continuum of information or effective transfer without loss of data and information. Construction sites have multiple stakeholders who may be present at the same time or at different times, which further complicates control and accountability. Moreover, records of individuals and materials entering and leaving from the construction sites are not typically recorded on an ongoing basis and are seldom part of a record for all current and future stakeholders.

Control and confirmation of deliveries at construction sites is limited, requiring the mere signature or sign off of any individual on the construction site in order for the deliveries to be accepted, or in many cases, deliveries are made to unattended sites with delivery drivers' self-verification. Unattended deliveries are in jeopardy of theft. Deliveries may arrive unscheduled, out of sequence, and/or delayed to sites creating delays, and the records of deliveries may be limited, often consisting of paper receipts. The deliveries may be made regardless of weather conditions, resulting in some materials being subject to rain and other weather conditions that may affect the materials that are delivered. This can result in legacy issues for warranties and quality. At large sites, errors may occur with deliveries to the wrong location or wrong contractor as different trades may use common materials.

Construction sites are some of the most dangerous places to work. They are difficult to control, secure, and provide accountability and coordination between the multiple stakeholders over a complex and complicated process. Access to controlled areas of a construction site is difficult to set, maintain, and monitor. Despite regulations and best efforts, many of the workers may not be covered by Workers Compensation Insurance. Safety briefings, appropriate individual safety equipment, disclosure lists of dangerous or hazardous materials with corresponding emergency procedures are difficult to locate on most construction sites, if they even exist. Use of tools and equipment by unlicensed, untrained, or uncertified workers is common, and may result in serious accidents.

Construction workers are the lifeblood of a construction site. Accounting for their comings and goings, verifying their licensure, confirming their payroll, and even confirming their location on the construction site is difficult. Confirmation of real time progress to optimize and improve efficiency and scheduling requires a constant and coordinated supervisory presence.

### SUMMARY

The exemplary embodiments described herein attempt to provide solutions to the problems discussed above. In accordance with an exemplary embodiment, a site supervisor system is for use at a construction site. The system includes a biometric-based identification device for capturing biometric data from an individual. The biometric-based identification device may be, for example, one of a facial recognition device, a fingerprint-based recognition device, a retinal scanner, a voice print recognition device or a hand scanning recognition device. The system also includes processing logic for analyzing the biometric data of the individual to determine the identity of the individual. Based on the analyzing, a determination may be made that the individual is permitted to access a portion of the construction site or a determination may be made that the individual is not permitted to access at least a portion of the construction site. When an individual is not permitted to access at least a portion of the construction site and attempts such access, an alarm may be triggered, or a notification may be sent to a predetermined party. A storage device may be included in the system for storing information and/or computer program instructions.

The site supervisor system may include at least one location tracking device, such as a global positioning system (GPS) device, a Bluetooth device, a radio frequency identification (RFID) device, Near Frequency Communication (NFC) device, an ultra-high frequency (UHF) device and/or a beacon-based device, for receiving location tracking information regarding the position of the individual on the construction site. The at least one location tracking device may track a location of one or more materials at the construction site. The at least one location tracking device may also be configured to receive information regarding the location of other individuals at the construction site. The storage device may store the information regarding the position of the individual on the construction site over time. The storage device also may store information regarding the locations of the additional individuals on the construction site over time. The processing logic may use information gathered from the at least one location tracking device to confirm what individuals and what materials are on the construction site.

The processing logic may be configured for generating a user interface that shows the locations of the individual and the additional individuals on the construction site. The processing logic may be used to compare projected process plan timelines with actual completed tasks timelines compared to the tracked movements of individuals. The processing logic may be configured to perform geofencing for the construction site. The processing logic may generate an alert when an individual is in a prohibited area as defined by the geofencing.

The site supervisor system may include a weather station for providing weather information. More generally, the site supervisor system may include a source or interface for providing weather information. There may be in some embodiments software executed by the processing logic for obtaining current weather information at the site supervisor system, such as from a weather service. The current weather conditions may be recorded along with a current sequence of construction at the construction site.

The site supervisor system may store permission information regarding the permissions granted to individuals for the construction site. The site supervisor system may use the processing logic for accessing the permissions and for reviewing the location information to determine whether to grant access to at least one tool, equipment, power, water, natural gas, or other utilities, or areas at the construction site. The processing logic may control at least one smart lock to grant or deny access to at least one of the tools, equipment or areas of the constructions site. The processing logic may examine a current time and/or date in determining whether to grant access. The processing logic may examine a current time relative to a permitted time range in which the individuals are granted access to at least a portion of the construction site in determining whether to grant access. Current weather conditions may also be consulted in determining whether to grant access.

The site supervisor system may include a computing device with a display and an input mechanism for providing input to the computing device. The display may be a touchscreen display. The site supervisor system may include power outlets for providing power. The processing logic may monitor and record power usage via the power outlets in the storage. A control mechanism may be included in the site supervisor system for controlling access to at least one additional utility other than power (such as gas, water, etc.). The control mechanism may physically block or grant access to the power supply plug(s). For example, a door or gate may be provided to control access to the power supply plugs. The control mechanism may instead in some embodiments control access by controlling whether power is provided to the plug(s). The site supervisor system may include sensing and/or scanning technologies for delivery of items to the construction site. The sensing technology may be, for example, a Near Frequency Communication (NFC) device, a bar code scanner, a QR code scanner, radio frequency identification (RFID) or ultra-high frequency (UHF) detectors. The site supervisor system may be contained within a kiosk.

The processing logic of the site supervisor system may be configured to gather worker's compensation information and report any resulting worker's compensation claim. A video conference to a designated party may be initiated by the processing logic to gather the worker's compensation information and report any resulting worker's compensation claim. The processing logic may be configured to gather information regarding an injury at the construction site and to report the injury to a designated party. A video conference may be initiated by the processing logic to gather the information regarding the injury and to report the injury. The processing logic may be configured to provide a user interface for reporting any injuries or an absence of injuries for a time period.

A display may be provided as part of the site supervisor system for displaying information for treating an injury. The display may also display information regarding handling of hazardous materials. The site supervisor system may include one or more cameras. The processing logic may enable an external party remote from the construction site to view a live feed from the cameras.

In accordance with another exemplary embodiment, a site supervisor system is provided for use at a construction site. The system includes sensing technology for sensing at least one item being brought to the construction site. The system includes a storage device and processing logic. The processing logic is for processing information sensed by the sensing technology to establish an identity and a quantity of at least one item. The processing logic stores information regarding the identity and the quantity of at least one item in the storage device. The processing logic may be configured to confirm delivery of items at a designated location.

The system may include tracking technology for tracking a location of at least one item at the construction site. The tracking technology may be Near Frequency Communication (NFC) technology, GPS-based technology, radio frequency identification (RFID) technology, ultra-high frequency (UHF) technology and/or beacon-based technology. The sensing technology may be used for sensing at least one item being relocated to an unapproved area or being removed from the construction site. The processing logic may process information sensed by the sensing technology to identify the at least one item being removed from the construction site and a quantity being removed. This information is stored within the storage device by the processing logic. The sensing technology may be a bar code reader, a QR code reader, an RFID reader, a machine vision system or the like. The system may be in a kiosk.

In accordance with another embodiment, a method is performed by a site supervisor system at a construction site. The site supervisor system includes an image capture device, processing logic and a storage device. Per this method, an image of an individual is captured with the image capture device at the construction site. The processing logic is used to perform facial recognition on the image of the individual to attempt to identify the individual. Where the facial recognition fails to identify the individual, the system may ask for verification using the screen input device. Where the identity of the individual fails to be confirmed in any one of the methods, access to the construction site, or a portion thereof, is denied. Where the facial recognition identifies the individual, based at least in part on the determined identity, access may be granted or denied to the construction site or a portion thereof.

Permission information for the individual may be stored in the storage device. This permission information may be accessed in granting access or denying access to the individual. The permission information may include time and date information for which the individual is granted access to the construction site, or a portion thereof. The grant or denial may be based in part on the current date and time. The current weather conditions may also be consulted in granting or denying access to the individual to the construction site or a portion thereof. The processing logic may perform geofencing such that the individual is granted access to an area of the construction site but not to another area of the construction site.

In accordance with an exemplary embodiment, a method is performed by a site supervisor system at a construction site. The site supervisor system includes a biometric-based identification device for identifying an individual based on biometric data. The site supervisor system also includes a storage device for storing permission information and processing logic. Per the method, biometric data is obtained from an individual via the biometric-based identification device. The biometric data is processed with the processing logic to attempt to determine the identity of the individual. Where the identity of the individuals is determined and the permission information indicates that the individual is entitled to access, at least one smart lock is controlled to grant access to at least one tool, piece of equipment or area of the construction site. Where the identity of the individual is not determined or where the permission information indicates that individual is not to be granted access, at least one smart lock is controlled to deny access to at least one tool, a piece of equipment or an area of the construction site. The obtaining of the biometric data may comprise capturing an image of the individual, and the processing of the biometric data may comprise performing facial recognition of the image to attempt to determine the identity of the individual. The biometric data may be, for example, one of fingerprint data, retinal scan data, voice print data or hand scan data.

In accordance with an exemplary embodiment, a method is performed by a site supervisor system at a construction site. The site supervisor system comprises a biometric-based identification device for identifying an individual based on biometric data. The system also includes processing logic and a storage device for storing permission information. In accordance with the method, biometric data is obtained from the individual via the biometric-based identification device. The biometric data is processed with the processing logic to attempt to determine the identity of the individual. Where the identity of the individual is not determined, if the permission information indicates the individual does not have permission, the system may deny access to one or more power sources. Where the identity of the individual is determined and the permission information indicates that the individual has permission to access one or more power sources, access is granted to the one or more power sources.

The site supervisor system may have at least one power plug and granting access may comprise providing power to at least one power plug and physically providing access to the at least one power plug. Denying access may comprise providing no power to at least one power plug and/or physically blocking access to the at least one power plug. The power plug may include a first power plug providing power at a first voltage level and a second power plug providing power at a second voltage level. Granting access may comprise granting access for only one of the power plugs based on projected voltage level needs for the individual in some instances. In other instances, all of the power plugs may be accessible or not accessible, such as when a gate or door is used to control access. How much power is consumed by the individual and over what time period may be recorded in the storage device.

In accordance with an exemplary embodiment, a method is performed by a site supervisor system at a construction site. The site supervisor system comprises a computing system and processing logic that allows for machine learning to improve techniques and procedures.

In accordance with an exemplary embodiment, a site supervisor system includes a processing logic and a storage. The system performs a method. The method includes receiving information at the site supervisor system from a wearable worn by an individual on a residential construction site. The information may be, for example, location information or biometric data. Examples of biometric data include heart rate, respiration rate, body temperature and blood pressure. The received information is stored and analyzed by the processing logic to determine whether an action needs to be taken based on the received information. Example actions include triggering an alarm, sending a communication to the wearable to trigger an alarm, or contact a supervisor.

### BRIEF DESCRIPTION OF THE DRAWINGS

FIGS. 1A-1D depict various side views of an exemplary site supervisor system kiosk for an exemplary embodiment.

FIG. 1E depicts a block diagram of components that may be found in a site supervisor system in exemplary embodiments.

FIG. 2A depicts a block diagram of components that may be found in a computing device for a site supervisor system in an exemplary embodiment.

FIG. 2B depicts an illustrative user interface that may be shown on a display in the site supervisor system.

FIG. 2C depicts a flowchart of steps that may be performed by the site supervisor system to control access by workers to hazardous materials.

FIG. 2D depicts a flowchart of steps that may be performed regarding injuries and worker's compensation.

FIG. 3 depicts an example of a distributed environment in which multiple site supervisor systems communicate with a server having access to a storage device.

FIG. 4 depicts a flowchart illustrating the steps that may be performed in determining whether to grant access to a construction site to an individual.

FIG. 5 depicts a flowchart illustrating steps that are performed in instance in which facial recognition is performed on an individual to determine whether the individual is granted access to the construction site.

FIG. 6 depicts various types of biometric data that may be gathered and used by the site supervisor system.

FIG. 7 illustrates a number of types of events that may be triggered when the identity of an individual cannot be determined.

FIG. 8 depicts a flowchart illustrating the steps that may be performed upon a contractor entering the construction site.

FIG. 9 depicts a flowchart illustrating steps that may be performed in controlling smart locks at the construction site by the site supervisor system.

FIG. 10 depicts a flowchart illustrating the steps that may be performed to obtain wearables at a construction site.

FIG. 11 depicts a flowchart showing steps that may be performed during geofencing at the construction site.

FIG. 12A shows a plan view illustrating components of an illustrative construction site.

FIG. 12B depicts illustrative geofencing areas in the example construction site of FIG. 12A.

FIG. 13 illustrates possible responses that may be taken when an individual is outside a permitted area at the construction site.

FIG. 14 depicts a flowchart illustrating the steps that may be performed in returning a wearable at the construction site.

FIG. 15 depicts a flowchart illustrating the steps that may be performed to grant or deny access to a power source at the construction site.

FIG. 16A depicts a flowchart illustrating steps that may be performed in the tracking of biometric data at the construction site.

FIG. 16B illustrates possible responses when tracked biometric data for an individual lies outside of an acceptable range.

FIG. 17 depicts a flowchart illustrating steps that may be performed in tracking equipment, tools or materials at the construction site.

FIG. 18 illustrates possible responses when the equipment, tools and materials are tracked as being outside of an acceptable location.

FIG. 19 depicts a flowchart illustrating steps that may be performed at the time of delivery of items to the construction site.

FIG. 20 illustrates different types of input technology that may be used for monitoring deliveries.

FIG. 21 depicts a flowchart illustrating steps that may be performed by a delivery person to enter delivery information into the site supervisor system.

FIG. 22 depicts a flowchart illustrating steps that may be performed by an inspector to enter information into the site supervisor system.

FIG. 23 depicts a flowchart of steps that may be performed regarding an external party requesting access to an image capture device of the site supervisor system.

FIG. 24 depicts a flowchart of steps that relating to using multiple image capture devices from adjacent site supervisor systems.

FIG. 25 depicts a flowchart of steps that trigger weather protocols.

### DETAILED DESCRIPTION

Exemplary embodiments provide a site supervisor system for providing security and controlling access to a construction site. The site supervisor system may monitor and record information regarding individuals entering and leaving the construction site. The site supervisor system may also monitor the perimeter of the construction site to provide security, especially during non-working hours. The site supervisor system may use biometric-based identification devices to confirm the identity of individuals entering or leaving the construction site. In addition, the biometric-based identification devices may also be used to identify individuals on the perimeter of the construction site.

Site supervisor systems at nearby construction sites may be interconnected using image capture devices, such as still cameras or video cameras, to provide security not only to the site on which it is stationed, but nearby sites as well. The processing of images from the multiple interconnected site supervisor systems may be performed via processing logic to identify security issues.

Confirmation of actual workers on site, and correspondingly, coverage by workers compensation insurance, licensing of workers, training for tools and jobs, and possession and usage of appropriate safety equipment is elusive. Onsite accident and claims management with immediate access to emergency care facilities and hazardous materials protocols is rare.

A system utilizing biometrics for verification of actual workers on the construction site to correspond with professional licenses and work certifications for verified payroll and insurance coverage would optimize processes and ensure coverage. Onsite verification of processes, inspections, completions and deliveries with automated adjustments and notifications with confirmation would ensure increased productivity. Real time construction plans with corresponding training and construction manuals would improve quality control and efficiency but rarely exist.

Automated verification of quantities, quality, and correct product deliveries along with after delivery tracking of materials with accountability is seldom used. Designated delivery areas with geofenced control and tracking of materials once delivered would help prevent loss. Confirmation of products integrated at a construction site provides transparency regarding sourcing, warranties, as well as future reference during the structure and individual products life of use.

The site supervisor system seeks to identify all individuals entering or leaving the construction site and persistently records this information in a storage, such as in a database. Such records may be useful in a number of different contexts. The biometric-based identification device may be a camera or other image capture device that obtains a facial image of a party. Facial recognition is performed on the captured facial image to attempt to identify the individual. Alternative biometric-based identification devices, such as voice recognition systems, retinal scans, fingerprint scanners, hand scanners, voice print devices and the like may be utilized in the alternative or in addition to other biometric devices. As a last resort, the computing logic may allow authorized individuals to manually enter the presence of another authorized individual.

The site supervisor system may record the time of arrival and the time of departure of individuals from the construction site. The site supervisor system may also record the date and current weather conditions. As such, the site supervisor system may confirm that the workers were at the construction site for the intended time windows and can record the hours that the workers worked to ensure that the workers are paid correctly. The site supervisor system may also compare the worker arrival and departure information to ensure that the worker arrives in a timely fashion and on the proper date. The weather information may be used to modify the schedule for workers so that workers are not working during inclement weather and to record the weather conditions at the time that the worker worked. Additionally, the processing logic may prevent work from being performed if said work would violate manufacturer guidelines for installation/application. The recorded information may also be useful in providing or disproving insurance claims or worker's compensation claims. The recorded information may also be useful to confirm installations or adherence to manufacturer specifications related to temperature or weather-related conditions.

If the site supervisor system determines that an unidentified individual attempted to enter the construction site, the site supervisor system may take the appropriate responses, such as sending notifications, triggering alarms and/or contacting law enforcement authorities or security personnel. The decision as to the appropriate response may be determined by, the date, the time current weather conditions, or related factor.

The site supervisor system may also control access to tools, equipment, materials and areas of the construction site. As to tools, equipment and materials, the site supervisor system may confirm the identity of an individual and grant access to certain tools and equipment using smart locks and/or other technology. The site supervisor system may limit the dates and duration of access to the tools/equipment such that the tools/equipment must be returned within the specified date/time window.

The smart locks may also be used to limit access to certain portions of the project under construction. An individual's right to a portion of the construction site may be dictated by permissions that are stored through each party involved in the construction process. This may eliminate keyed entry during the process and provide further verifications of individual or group access.

The individuals on the construction site may be prompted to wear certain wearables that provide useful information to the site supervisor system. For instance, individuals may be prompted to wear location tracking devices, such as GPS devices, Bluetooth, radio frequency identification (RFID) devices, ultra-high frequency (UHF) and/or beacon-based devices. The use of the wearables helps to perform geofencing within the construction site. The location tracking provided by the wearable helps the site supervisor system to monitor the location of individuals on the construction site on an ongoing basis. The permissions may define what portions of the construction site an individual may access. Ongoing monitoring may indicate that an individual is attempting to enter a location where the individual is not permitted. This may trigger a response, such as an alarm, a notification or even contacting of security or law enforcement officials. Individuals may be required to wear vests or other wearables that contain signaling capabilities. In such an instance, a signal may be sent to the vest or wearable to trigger a visual or audio cue that the individual is not in a permitted area. In addition, individuals may be requested to wear wearables that track biometric information, such as heart rate, body temperature, respiration rate and blood pressure. This information may be tracked and stored on an ongoing basis. When the biometric data gathered from these wearables are outside an acceptable range, which may indicate physical danger or injury, appropriate response actions may be taken such as notifying the individual, notifying a supervisor and/or contacting medical personnel. Collected data may be used to verify a multitude of factors such as reported accidents, incidents of theft, hours worked, and the like. The individuals on the construction site may be prompted to wear certain safety equipment related to their assigned tasks. The confirmation of the safety equipment may be useful in the prevention of accidents or in the prevention or lessening of injuries in the event of an accident.

The site supervisor system may track materials. When a delivery is made, the delivery person may enter delivery notes and the delivered materials may be scanned or read to confirm the quantity and nature of what has been delivered. This information may be recorded. Additional information, such as current weather conditions may also be recorded. The site supervisor system may track the movement of materials, tools and equipment at the construction site. Scanning technology such as RFID readers, UHF readers and the like may be utilized to assist the location tracking for tools, equipment and materials. The tracking of materials helps reduce the risk of theft. For example, the tracking solution may indicate instances of possible theft, such as when the materials are leaving the construction site when the removal of the materials is not appropriate.

The site supervisor system may allow for the establishment of one or more geofenced delivery zone areas. These areas could be monitored and established with additional access restrictions to individuals to further prevent loss or damage of materials.

The site supervisor system may control access to power by individuals of the construction site. The site supervisor system may provide a number of power outlets and may grant access to the power outlets as warranted. The use of power is recorded by the site supervisor system. Different levels of voltage may be provided as required. Parties using the power outlets may be billed appropriate amounts based upon the recorded power usage.

The site supervisor system may also interface with the inspectors such that an inspector may enter notes and related details of an inspection. The site supervisor system may allow the inspector to capture images of notes, forms, and the like using various solutions.

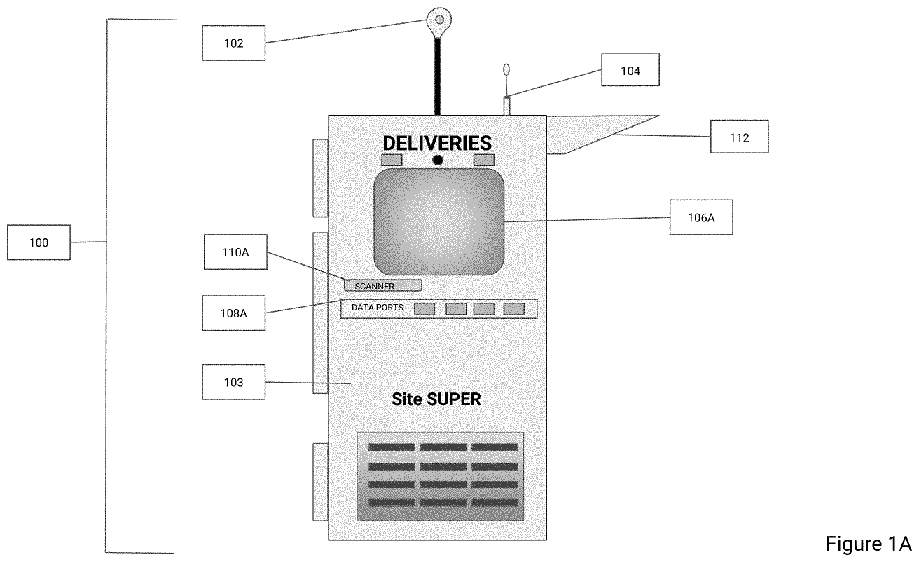

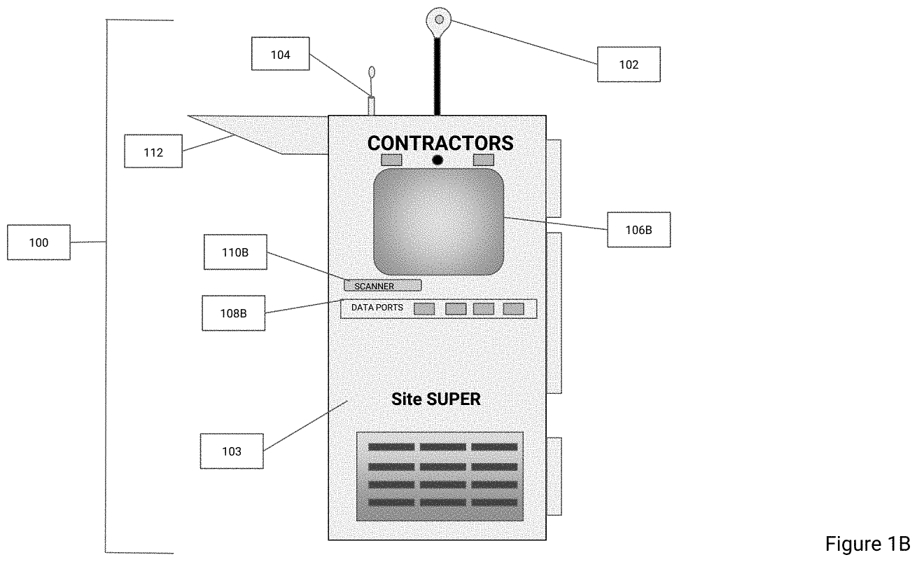

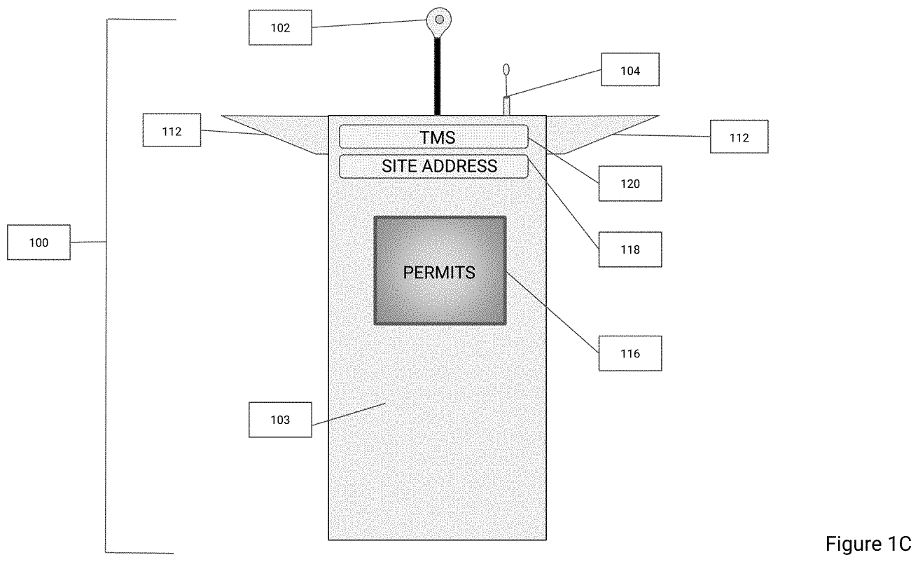

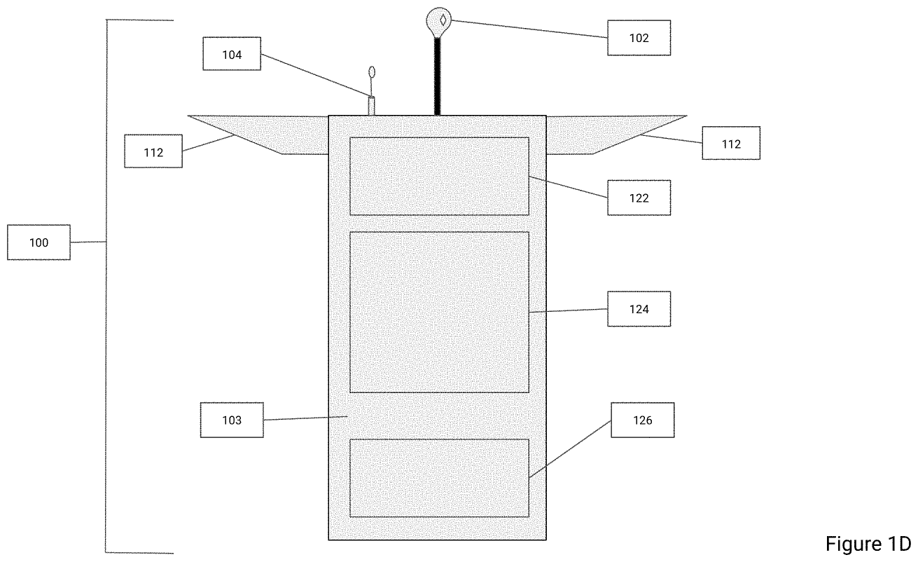

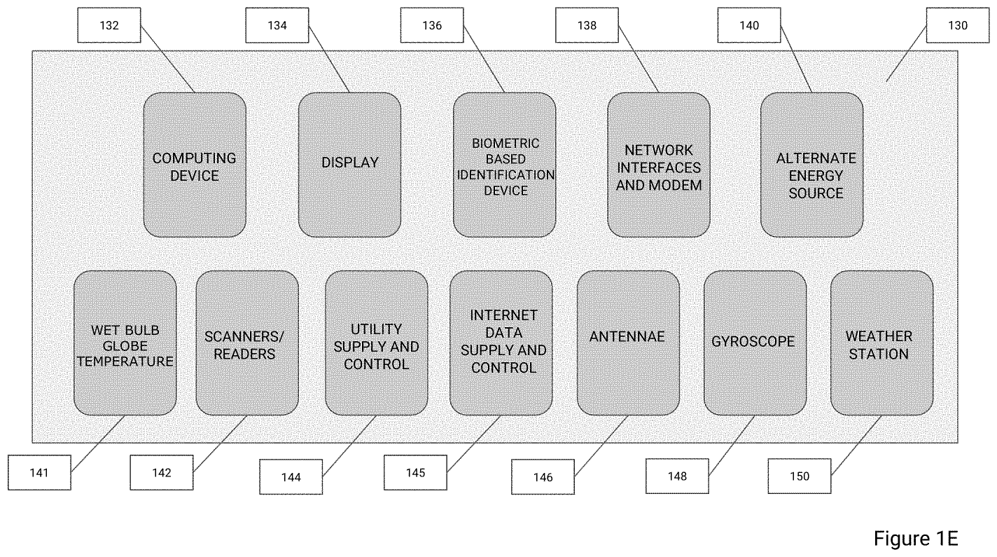

The site supervisor system gathers a great deal of information over the course of time. At least a portion of this information is persistently stored to compile a record of activities at the construction site. This record can be useful to prove activities after the fact. The activities that are recorded may drive workflow and scheduling at the construction site to improve efficiency and productivity Storage of information also maintains records in the event of a malfunction or power outage. FIGS. 1A-1D illustrate an example of a site supervisor system for an exemplary embodiment. In FIGS. 1A-1D, the site supervisor system is implemented as a kiosk 100. The kiosk 100 may be located at a construction site. One suitable approach is to pour a concrete slab and then position a kiosk on the slab in a secured manner.

FIG. 1A shows a first side of the site supervisor system kiosk 100. The kiosk 100 includes a camera 102 for obtaining images of individuals entering or leaving the construction site as well as images of individuals along a perimeter of the construction site. As will be explained in more detail below, the camera 102 may capture facial images upon which facial recognition may be performed. We may use many cameras on, in, or around the kiosk to achieve the needed data. These cameras may be placed on or around the kiosk 100. It should be noted that the kiosk 100 may include an addition to the camera 102 or instead of the camera 102, biometric-based identification devices that are used to confirm the identity of individuals entering, leaving or on the perimeter of the construction site. The kiosk 100 includes an antenna 104 for communicating with a wireless network, such as a WiFi network, Bluetooth or a 4G/5G cellular network. The kiosk 100 may include a housing 103 made of suitable weather resistant material, appropriately sealed to protect the internal hardware. The kiosk 100 may include a display 106A, such as a touchscreen display, upon which information may be displayed and entered. The display 106A may include an integrated camera that may be used to capture images and that may be used in performing facial recognition of individuals. The display may also include one or more integrated speakers for providing audio output. The kiosk 100 may include data ports 108A that may be utilized to input or output information relative to the kiosk 100. The kiosk 100 may include a scanner 110A for scanning items, such as deliveries, as will be explained in more detail below. The scanner 110a may be, for example, a QR scanner, an Optical Character Recognition (OCR) or a bar code scanner 110A in some instances. The side of the kiosk 100 shown in FIG. 1A is intended to be used for deliveries. Thus, a delivery person may scan delivered items via the scanner 110A and may interface with the kiosk using the touch screen display 106A, as will be described below. In some alternative embodiments, there may be fewer sides in which to interact with the kiosk for all authorized personnel. An overhang 112 may be provided to assist in decreasing glare and protecting some of the items on the kiosk from the weather.

FIG. 1B depicts another side of the kiosk 100. This side also includes a touch screen display 106B as well as a scanner 110B. Like display 106A, display 106B may include an integrated camera and/or speakers for providing audio output. Still further, this side of the kiosk 100 may include data ports 108B. This side of the kiosk is intended for use by contractors (e.g. workers and other construction related personnel). The kiosk 100 may be accessed to gain access to equipment, tools and to sign in or sign out when leaving or entering the construction site, as will be described below.

FIG. 1C shows a third side of the kiosk 100. This side has a location 116 in which permits may be displayed. In some alternative embodiments, the permits may assume electronic form so that a video display is provided in the area 116 of the kiosk 100. The tax map sequence (TMS) number 120 for the construction site location may be displayed on the kiosk 100. In addition, the site address 118 may be displayed on the kiosk 100. The site address may refer to both the mailing address for the construction site and/or the GPS location.

FIG. 1D shows the final side of the kiosk 100. An access panel 122 may be provided to access a breaker box for the kiosk 100. An additional access panel 124 may also be provided to access internal components of the kiosk 100. Still further, access panel 126 may be provided to gain access to power plugs for providing power at the construction site. The access panel 126 may be under programmatic control in some instances to regulate access to the power plugs. If access is granted, the panel is unlocked, whereas if access is denied, the access panel 126 is locked. In some embodiments, access to the power supply may be controlled by controlling the flow of power to the power plugs under programmatic control. These control mechanisms may be used separately or in conjunction.

It should be noted that in alternative embodiments, the supervisor system need not be implemented as a kiosk. Instead, separate components that are not housed in a common housing may be utilized in some alternative embodiments.

FIG. 1E depicts components that may be found in the site supervisor of exemplary embodiments even when not housed in a kiosk. The site supervisor may include a computing device 132. The computing device 132 may take many different forms indicating a desktop computing device, a laptop computing device, a mobile computing device, an embedded system, a smartphone or the like. A display 134 may be integrated with the computing device 132 or as a separate device, such as a liquid crystal display (LCD) device, a light emitting diode (LED) display device or other types of display devices on which computer information may be displayed. One or more biometric-based identification devices 136 may be provided. As will be explained in more detail below, multiple biometric-based identification devices may be used. Network interfaces and a modem 138 may be provided. The network interfaces may interface the computing device 132 with a local area network or a wide area network. The network may be wired or wireless. A modem may be provided in order to communicate telephonically or over cable lines with remote computing devices.

The site supervisor system 130 may be implemented in a distributed fashion and may include an alternative energy source 140. For example, solar panels, wind turbine(s), a battery or the like may be used. In a kiosk implementation, the alternative energy source may be physically affixed to the kiosk. For example, solar panels or a cable to a wind power source could be affixed to the kiosk. Alternatively, a power line leading to the alternative energy source may be connected to the kiosk to provide power for the kiosk.

The site supervisor system 130 may include various scanners and readers 142, such as those described above relative to kiosk. The site supervisor system 130 may include a utility supply and control 144 and a mechanism for turning the utilities, such as power, gas and/or water, on and off under a programmatic control. The site supervisor system 130 may include an internet data supply control 145 and a mechanism for turning the access to this service on and off under a programmatic control. Programmatic control may be provided to grant or deny access to such resources. The site supervisor system 130 may include an antenna 146 for wireless communications signals to receive and transmit. The site supervisor system 130 may include a gyroscope 148 to monitor any moving of the system. The gyroscope 148 may indicate motion indicative of whether someone is trying to move or tilt the kiosk. Logic may be provided to send a notification in such an event where the gyroscope indicates substantial enough movement. The site supervisor system 130 may include a weather station 150 to measure current weather conditions, such as temperature, wind, precipitation, barometric pressure and the like. Input from the weather station 150 may be used to inform decision making by the site supervisor system in some instances. Alternatively, the weather may be collected via software, such as from a weather service or other weather source. Similarly, the site supervisor system 130 may include a wet bulb globe temperature device or a source of wet bulb globe temperature data 141. Wet bulb globe temperature is a measure of heat stress in direct sunlight, which accounts for temperature, humidity, wind speed, sun angle and cloud cover (solar radiation).

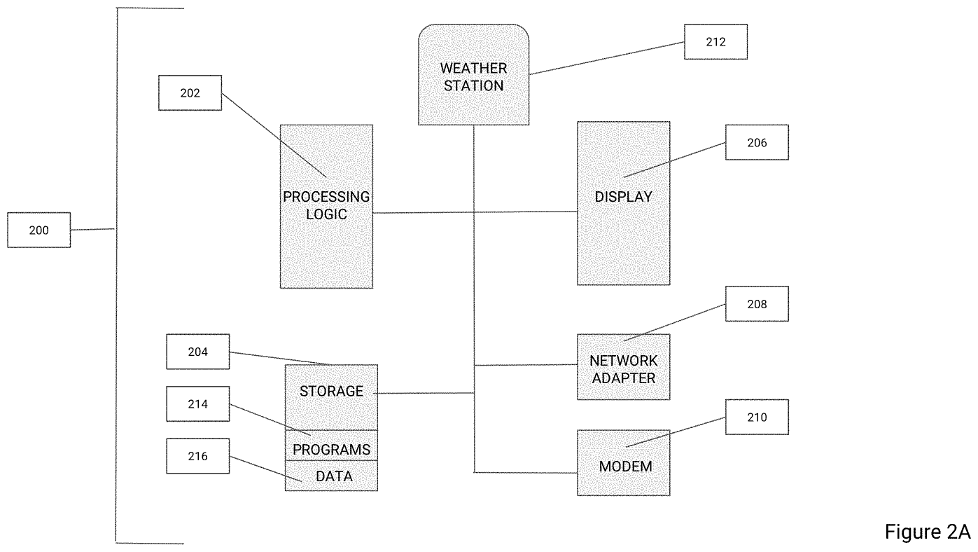

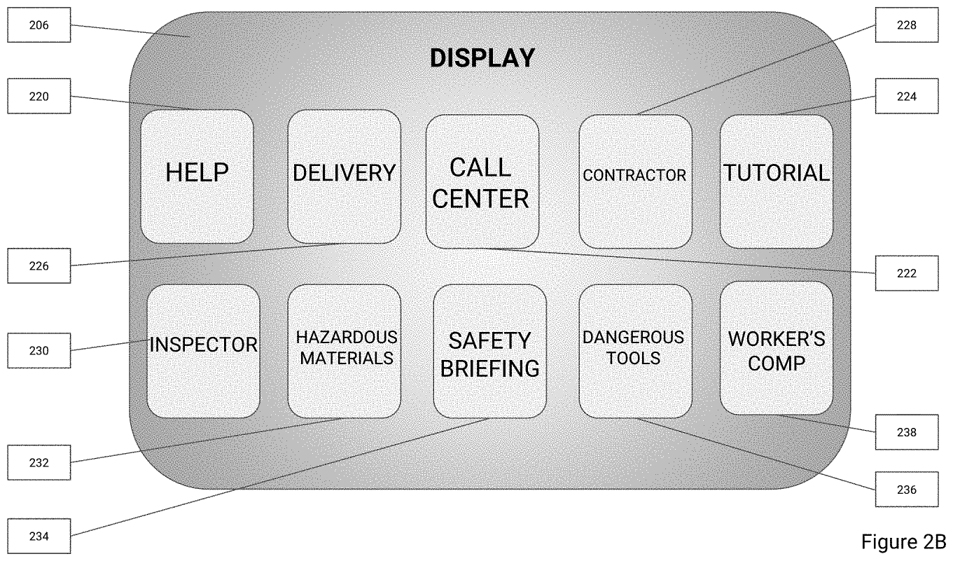

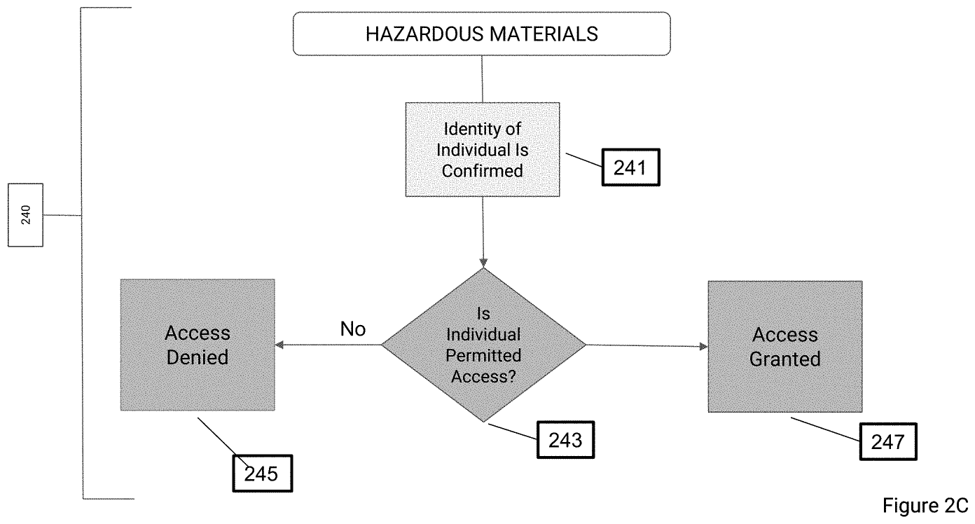

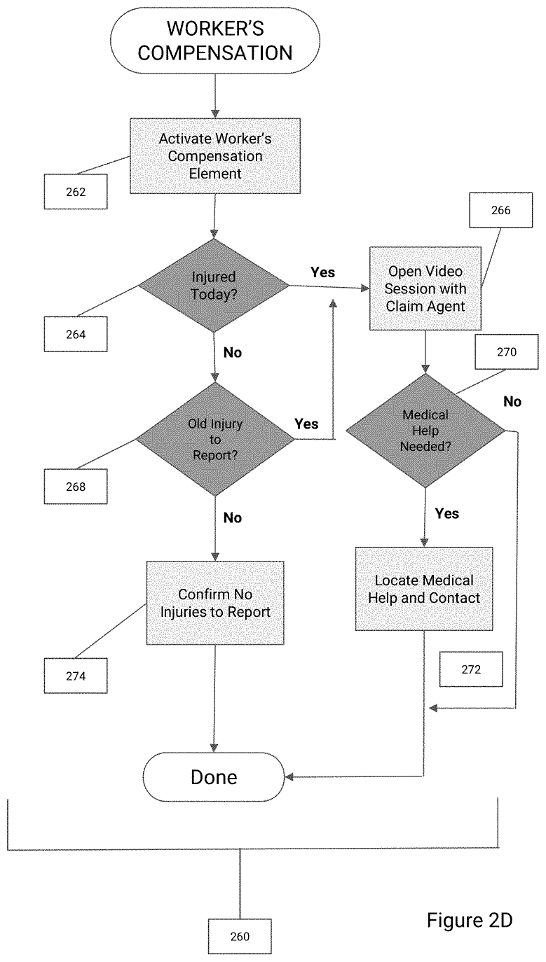

FIG. 2A shows an example of a computing device 200 for the site supervisor system. The computing system may include processing logic 202, such as microprocessors, controllers, field programmable gate arrays (FPGA), application specific integrated circuits (ASICs) electronic circuitry, and other types of logic. The processing logic 202 performs the operations of the computing device 132. A storage device 204 may also be provided. Storage capability 204 may take various forms, including magnetic storage, optical storage, etc. Storage capability 204 may include computer-readable media, including removable computer readable media, such as disks, thumb drives and the like, or disk drives, solid state memory, random access memory (RAM), read only memory (ROM) and other types of storage.

The computing device may include a display 206, such as an LCD display, an LED display or other types of display devices on which video information may be displayed. The computing device 200 may include a network adapter 208 for interfacing with networks and a modem 210 for communicating wirelessly, over telephone lines or cable lines with remote devices.

The processing logic 202 may use information stored in the storage device 204. In particular, the processing logic 202 may execute programs 214 stored in the storage and may access and store data 216 relative to the storage device 204. The computational functionality of the site supervisor system described herein may be realized by the processing logic 202 executing the programs 214.

FIG. 2B shows an example of a user interface on display 206, such as found in the kiosk 100. The user interface may include activatable elements. A user may depress these activatable elements or select these activatable elements using an input device, such as a mouse, keyboard, touchscreen or the like, to activate the components. The display 206 may include a help element 220 that may be activated to obtain help information regarding use of the kiosk. It may also contain real time construction plans. It may also include “how to” assistance including videos related to the various processes and tasks performed on the specific site. The user interface on the display 206 may also include a call center activatable element 222. Selection of the call center activatable element 222 may cause a call to be initiated with a call center so that the individual using the kiosk 100 may have a telephone and or video conference with personnel at the call center. The user interface on display 206 may also include a tutorial activatable element 224. Selection of the tutorial activatable element 224 causes a tutorial to be displayed to teach the individual about operation of the kiosk.

A list of hazardous materials at the site may be activated by activating element 232. This list is updated as hazardous materials are delivered, removed or consumed. Access to hazardous materials may also be controlled via the site supervisor system 130. FIG. 2C shows a flowchart 240 of steps that may be taken to control access to hazardous materials at the construction site. First, the identity of the individual is confirmed 241, such as described above using biometric identity verification. The permissions information is accessed to determine if the individual is to be granted access to the hazardous materials 243. If the permissions indicate that access is to be granted, access is granted 247. In contrast if the permissions indicate that access is not to be granted, then access is denied 245.

The user interface on display 206 (FIG. 2B) may also include a safety briefing activatable element 234. Activation of this element 234 results in a safety briefing being displayed on the display 206.

The user interface on display 206 may include a dangerous tool activatable element 236. Activation of this element 236 causes the display of a list of dangerous tools on the construction site. An individual must have the proper authorization or certification to use such dangerous tools. The authorization or certification may be stored with the permissions.

The site supervisor system 130 may include coding software which allows each tool to be assigned to authorized personnel. Utilizing this coding along with smart locks as previously mentioned, the site supervisor system 130 either unlocks or prevents access.

Selection of the worker's compensation activation element 238 may be required at the end of each work day or when an injury occurs. FIG. 2D provides a flowchart 260 of steps taken when the element 238 is activated 262. All workers may be required to enter this information each day. If the individual indicates that he/she has been injured 264, a video session with a claim agent is initiated 266. The claim agent may gather information to initiate any claim processing. The claim agent may determine if medical help is warranted 270. If medical help is warranted, the location of appropriate medical help is identified based on a location of the construction site (based on proximity and type of injury) and contact is made with the medical help (e.g., calling of an ambulance, hospital or urgent care facility) 272. The facilities may be chosen to be “in network” for the worker's compensation carrier. 266, 270 and 272 may also be performed in the instance in which the individual has an older injury to report 268. Where there is no injury to the individual, the lack of injury is reported 274.

Delivery personnel may activate the delivery activatable element 226 (FIG. 2B). This causes a delivery functionality to be displayed where delivery notes may be added and where information may be gathered from the delivery person regarding a particular delivery. A contractor activatable element 228 may be selected by contractor individuals. Selection of this activatable element 228 causes the activation of the contractor functionality whereby the contractor may sign in, request tools, equipment, power or materials, leave notes or the like. Lastly, an inspector activatable element 230, may be activated to cause the inspector functionality to be activated. The inspector functionality may enable an inspector to add inspection notes, provide electronic inspection certificates and the like.

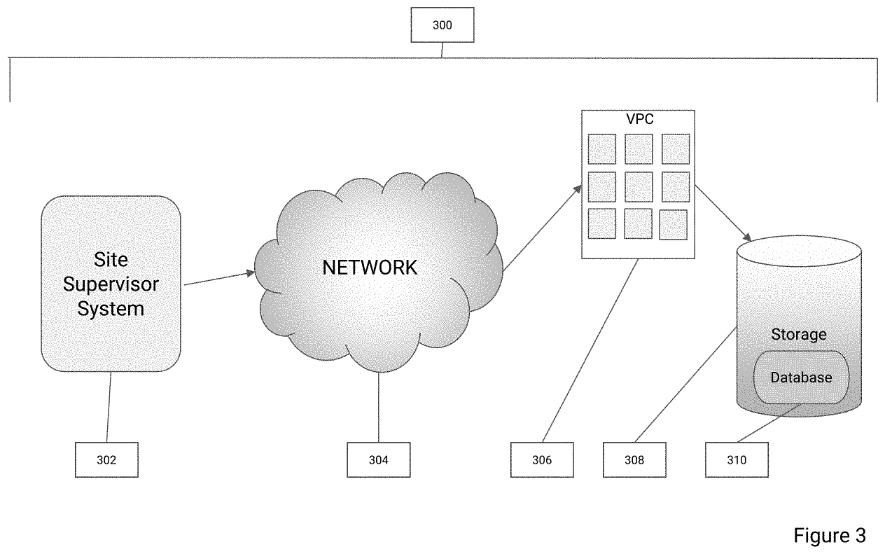

As shown in FIG. 3, one or more site supervisor systems 302 may be in communication with a remote cluster 306 via a network 304. The cluster 306 may store information received from the site supervisor system 302 and provide added computational functionality. The network may be a wired network or a wireless network or a combination thereof. The network 304 may be a secure internet connection extending between the site supervisor system 302 and the cluster 306, such as a virtual private cloud (VPC). The server may be a computing device. The cluster 306 may include access to storage 308. The storage 308 may include a database 310 in which information regarding a construction site is stored in a consistent manner.

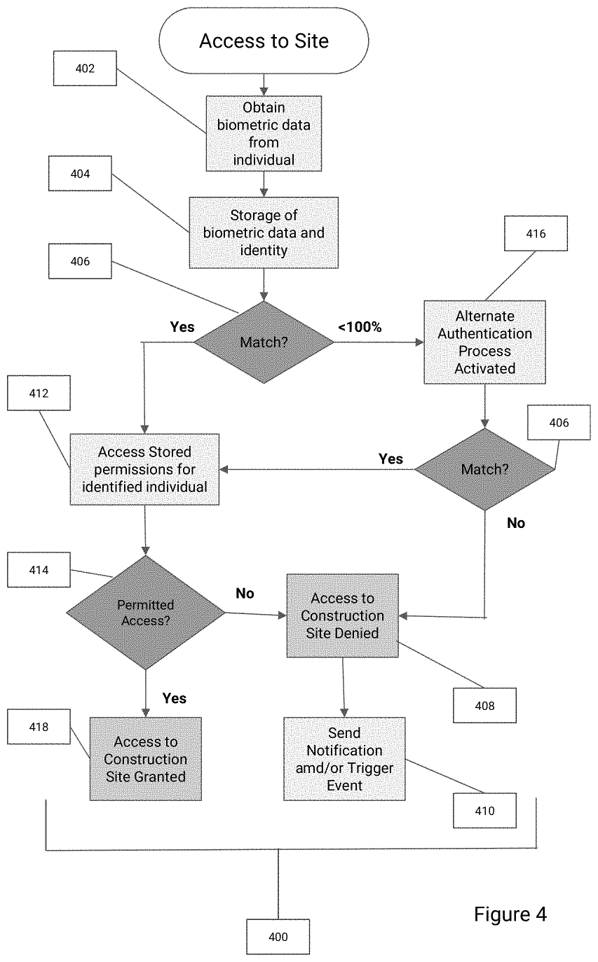

As was discussed above, the site supervisor system controls access to the construction site. FIG. 4 shows a flowchart 400 identifying steps that may be performed in exemplary embodiments regarding this functionality of the site supervisor system. Initially, biometric data is obtained from an individual that is seeking access to the site 402. As was discussed relative to the example of FIG. 1A in some exemplary embodiments, a camera 102 may capture an image of an individual and facial recognition may be performed. The biometric data in this case is the facial image of the individual. In other exemplary embodiments, the biometric data may be, for example, fingerprint data, hand scan data, voice print data, retinal scan data or the like, gathered by appropriate biometric-based identification devices. The obtained biometric data is stored, and then previously stored data is accessed from storage to compare biometric data for known individuals and to attempt to identify the individual 404. A comparison may be made between the gathered biometric data and the known biometric data to determine if there is sufficient closeness for there to be a match. Information regarding the identity of the individuals for which the biometric data is stored is also stored in the storage device. A determination is then made whether there is a match or not 406.

If there is not a match 406, a manual process may be executed, or an alternative authentication process may be deployed 416. If this alternative authentication fails to produce a match 406, access to the construction site may be denied 408. In addition, a notification may be sent to a responsible party and/or an event may be triggered, such as contacting security or law enforcement officials 410. If the alternative authentication process produces a match, the process proceeds to 412.

The site supervisor system may store permissions for each individual. These permissions may identify the dates and times where the individual is given access to the construction site. In addition, the permissions may specify what tools, equipment or materials the individual is allowed to access. The permissions may specify whether the individual is allowed to use a power supply and may specify what portions of the construction site the individual is permitted to access. These permissions may be accessed to determine the permissions for the identified individual 412. If the permissions indicate that access is permitted 414, the individual may be granted access to the construction site 418.

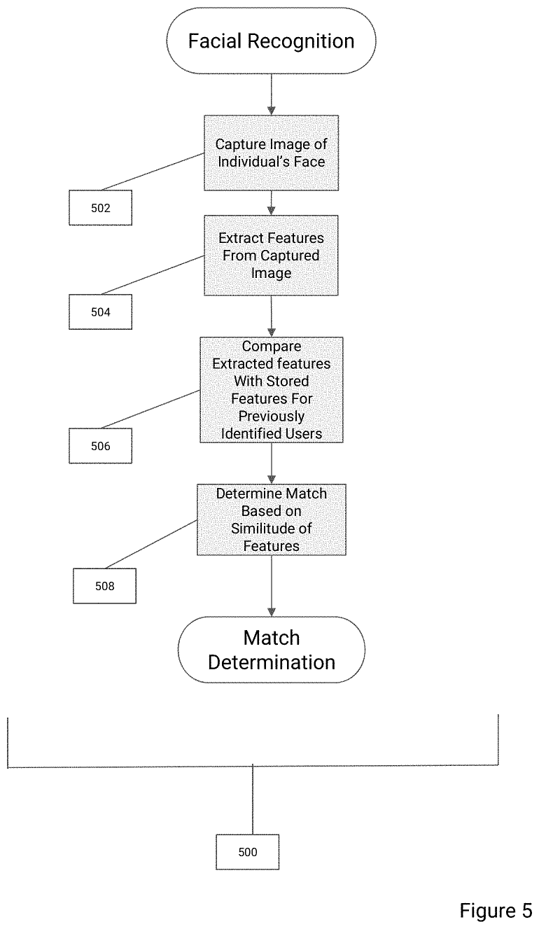

FIG. 5 shows steps that are performed in a case of facial recognition for 402, 404 and 406 of FIG. 4. The flowchart 500, regarding facial recognition, begins with 502 in which an image of the face of an individual is captured. This may be captured by a number of different types of image capture devices, including an intermittent video camera or other type of camera. In the case where an image of the face of an individual is captured, identifying features are extracted from the captured image 504. In other words, unique facial features that help to identify an individual are extracted from the image. The image may be filtered and/or normalized. The features are then compared with the stored features for identified individuals 506, determination is made whether there is enough similarity for there to be a match.

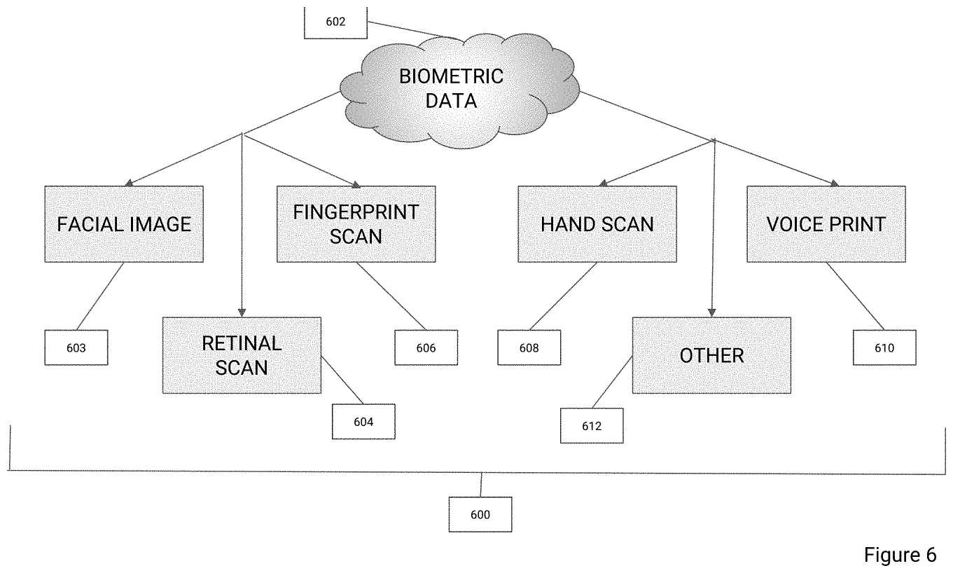

FIG. 6 shows a diagram 600 that illustrates various types of biometric data 602 that may be obtained by biometric-based identification devices at the construction site to attempt to identify individuals. Biometric data may include facial recognition 603, a retinal scan 604, a fingerprint scan 608, a hand scan 608 or a voice print 610. It should be noted that other types 612 of biometric data may also be used in exemplary embodiments to help identify individuals uniquely. Also, an individual may be required to provide multiple types of biometric data in some instances.

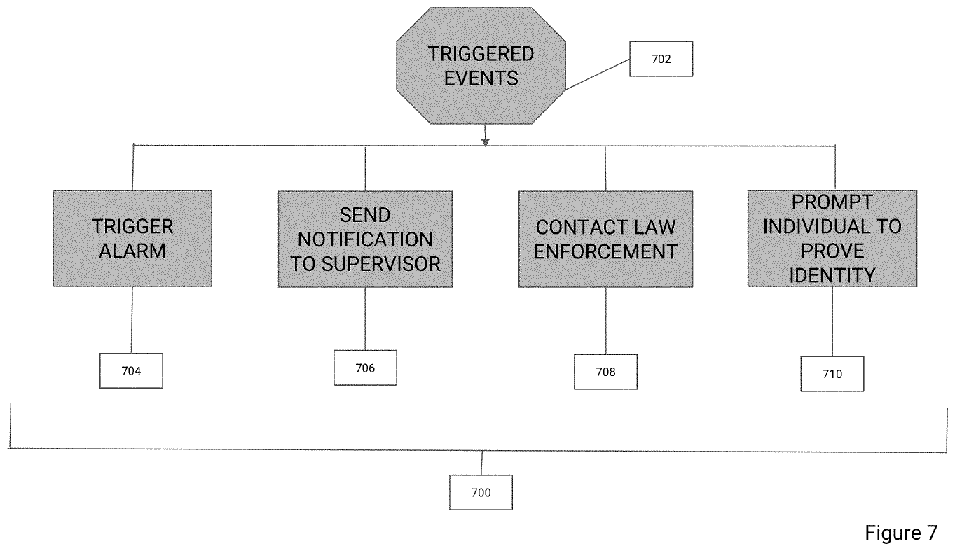

As was mentioned above, when an individual attempts to access the construction site and is not granted access, certain events may be triggered (see 410 in FIG. 4). FIG. 7 shows a diagram 700 that provides an example of different types of triggered events 702. One type of triggered event is an alarm 704. This alarm may include visual alerts, audio alerts or a combination thereof. The alarm may be a silent alarm to individuals. Another event that may be triggered is to send notifications to a supervisor for the construction site 706. The supervisor may, for example, receive an email, a text, phone call or other notification that someone is trying to access the site that is not permitted. A triggered event 702 may also include the contacting of law enforcement or a member of a security service indicating that an unauthorized party has tried to access the construction site. Lastly, a triggered event 702 may include prompting the individual to produce proper identifying information to an official at the site or to a scanning device at the kiosk 100.

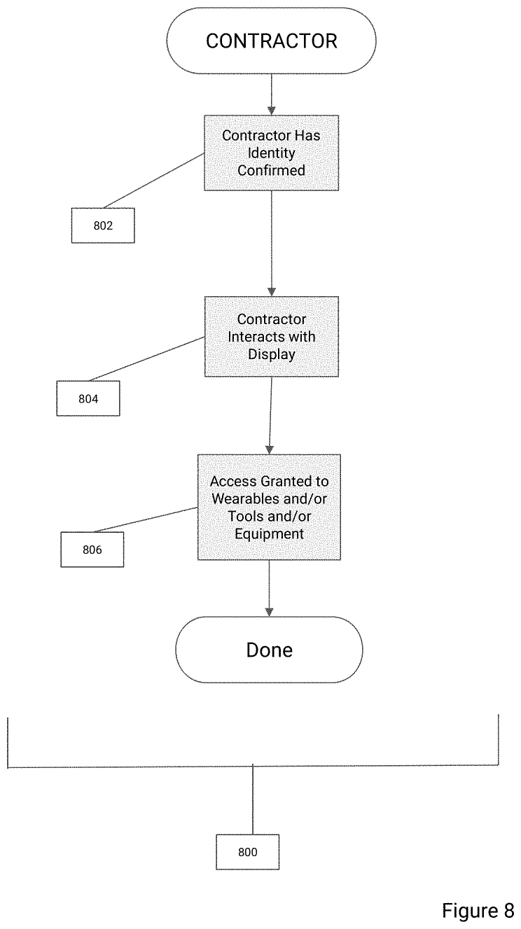

As was discussed above, individuals entering the construction site must subject themselves to collection of their biometric data to confirm their identity before they are granted access to the site. One type of individual is a contractor. FIG. 8 shows a flowchart of the steps that may be performed to ensure that the contractors gain access to the appropriate items once they have been granted access to the construction site. As shown in the flowchart 800 of FIG. 8, initially the contractor has their identity confirmed, as has been discussed above 802. The system may offer an alternative touchscreen option to place a call to the appropriate party should the software fail to verify an otherwise authorized individual. The contractor may be prompted to interact with the display, such as the touchscreen 106B (FIG. 1) to register and to indicate whether they seek certain items. For example, with the user interface of FIG. 2B, the contractor may activate the contractor activatable element 228. Access is then granted to wearables and/or tools and/or equipment 806. The wearables, the tools and/or equipment may be stored in sheds or in other secured locations under the control of smart locks that may be controlled by the computing system of the site supervisor system.

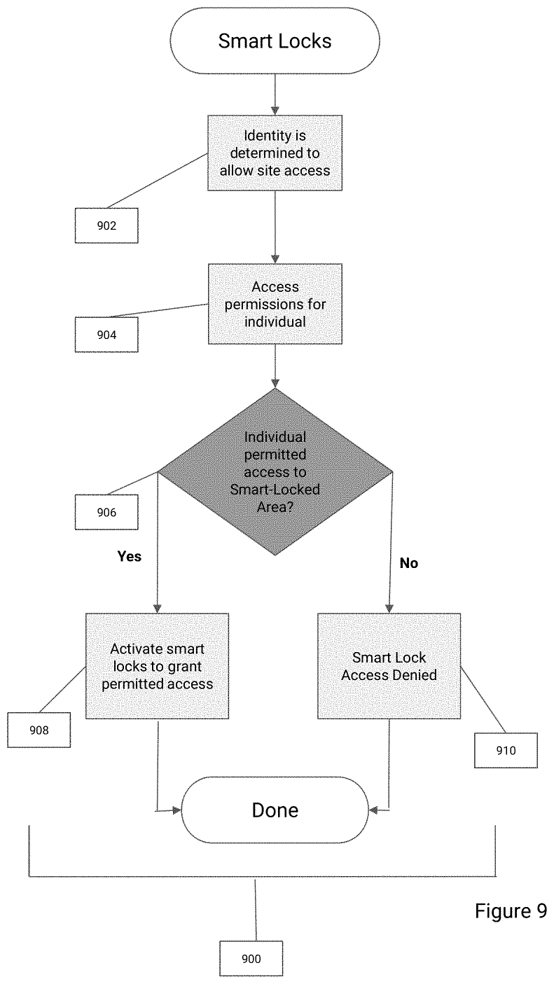

FIG. 9 provides a flowchart 900 of the steps that may be performed relative to smart locks at the construction site. The individual, such as a contractor, has his/her identity determined and has access to the construction site 902. The system may offer an alternative touchscreen option to place a call to the appropriate party should the software fail to verify an otherwise authorized individual. The permissions stored for the individual are accessed 904. A determination is made whether the individual is granted access to a smart locked area 906. If the individual has permission to access the area 908, the smart locks may be activated to unlock the area, such as where wearables, tools or equipment are located. Before the individual can use the tools/equipment, the individual may first be required to wear some of the wearables and to scan the tools or equipment to indicate that they will be using the tools or equipment. If the individual lacks the proper permissions to access the area, then access to the area is denied 910, such as by keeping the smart locks locked.

As was discussed above, the wearables may be used to track the location of individuals on the construction site and to gather biometric data. In addition, the wearables may serve as a mechanism for communicating with the individual or communicating information regarding individuals to parties with certain responsibilities over the constructions site.

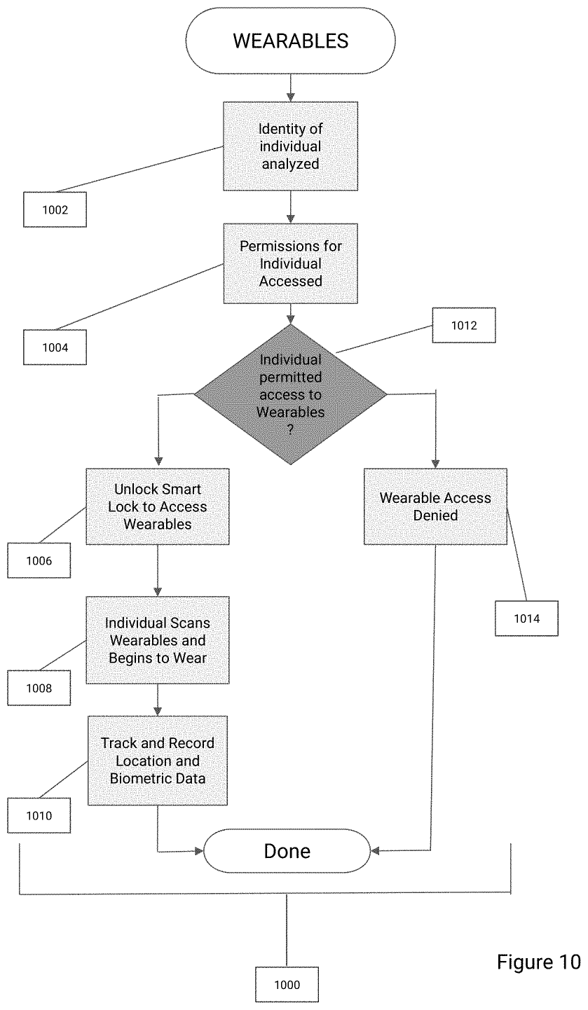

FIG. 10 contains a flowchart 1000 illustrating the steps that may be performed to obtain the wearables. The wearables include safety gear, such as hard hats, gloves, goggles, vests and the like, as well as wearables for tracking and obtaining biometric data. The identity of the individual is confirmed 1002, and the permissions for the individual are accessed 1004 and a determination is made based on the permissions if the individual should be granted access to the wearables 1012. The system may offer an alternative touchscreen option to place a call to the appropriate party should the software fail to verify an otherwise authorized individual. If it is determined that the individual should be granted access, the smart lock for the storage location of the wearables is unlocked 1006. The individual may then be prompted to scan information regarding the wearables so as to register the wearables and associate the wearables with the individual 1008. The site supervisor system may require that an individual wear certain safety equipment in the form of wearables. The site supervisor system may record what wearable the individual scans. The site supervisor system tracks and records the location and biometric data gathered by the wearables 1010. The wearables may include smart vests, bracelets, badges, sensors and the like that provide location information and biometric data, such as heart rate, body temperature, blood pressure breathing rate and/or other information. These wearables assist the site supervisor system in tracking the location of individuals of the construction site. These wearables also help to track the biometric data of individuals. The biometric data may be helpful in identifying that an individual is experiencing an accident, a health event or is idle. The biometric data is stored so that a record of the biometric data can be kept. If in 1005, it is determined based on the permissions that the individual should not be granted access, then access to the wearables is denied 1014.

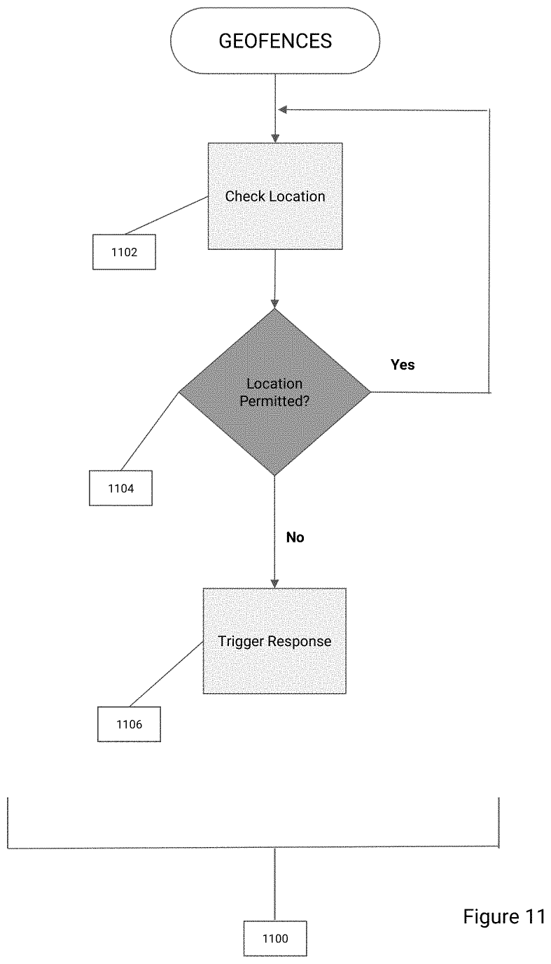

The use of the wearable to track location helps to facilitate geofencing in exemplary embodiments. The geofencing enables the site supervisor system to track and limit access to locations of individuals at the construction site. The construction site may be partitioned into areas where different permission rights are given for the various areas. For example, a plumber may be given access to the kitchen and the bathrooms of a project under construction but may be prohibited from being in the living room or the roof. As shown in FIG. 11, a flowchart 1100 shows some of the steps performed in secrecy. The process begins with the checking of the location 1102 of an individual. A determination is made in 1104 whether the individual is permitted to be at that location. If the individual is not permitted to be at that location, a response is triggered 1106.

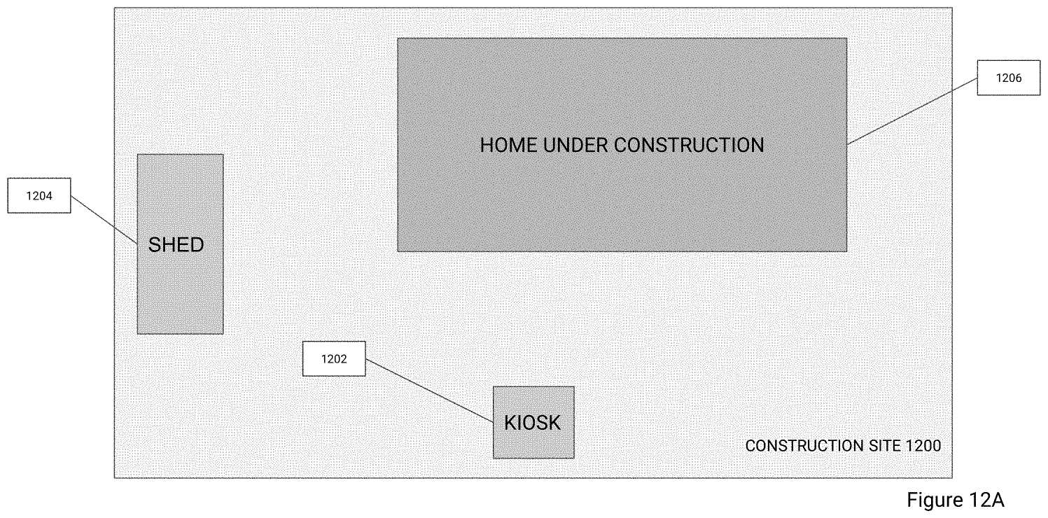

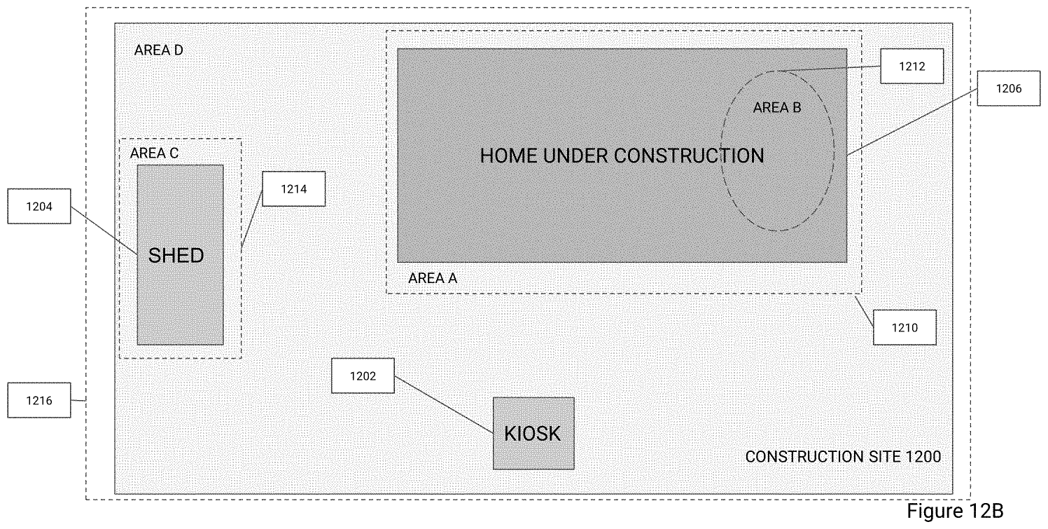

To help illustrate an example of geofencing, FIG. 12A shows an illustrative construction site 1200. The construction site 1200 may include a kiosk 1202 for the site supervisor system as well as a shed 1204. The shed 1204 may hold tools, equipment, wearables and/or materials. The construction site 1200 may also include a home or other building project that is under construction 1206.

FIG. 12B shows an example of different areas that may be established for geofencing at the construction site 1200. Area A shown by the phantom boundary 1210 may include the entirety of the project that is under construction 1206. Area B 1212 may be a portion of the project, such as the kitchen. Area C 1214 may be the shed and area D 1216 may be the entire construction site. Individuals may have access to none of these areas or to a subset of these areas, including all of the areas.

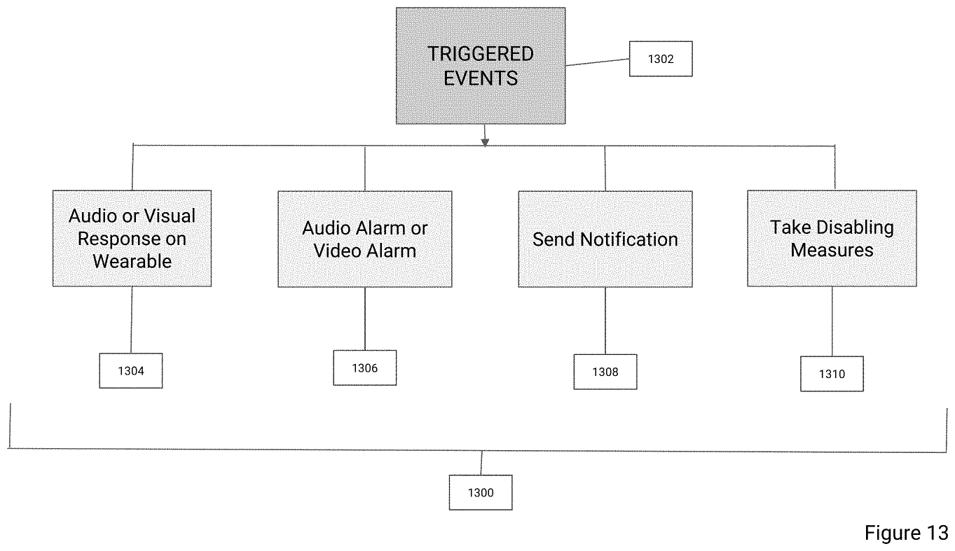

FIG. 13 is a diagram 1300 that shows exemplary responses 1302 that may be taken in response to a party being in areas of the construction site they are not permitted to be in. One option is for an audio or video response to occur on a wearable 1304. For example, a smart vest may include lights that may flash or may be continuously illuminated in response to a party being outside the permitted areas on the construction site. An audio alarm may also be triggered. Another option is for an audio alarm or a video alarm to be triggered at the construction site rather than on a wearable 1306. This alarm indicates that an individual is in a non-permitted area. A further option is to send a notification, such as a phone call, a text message, an email message or other notification to a supervisor on or off the construction site 1308. Yet another option is to take disabling measures relative to the individual 1310. The disabling measures could entail triggering locks or disabling equipment by shutting off power or the like.

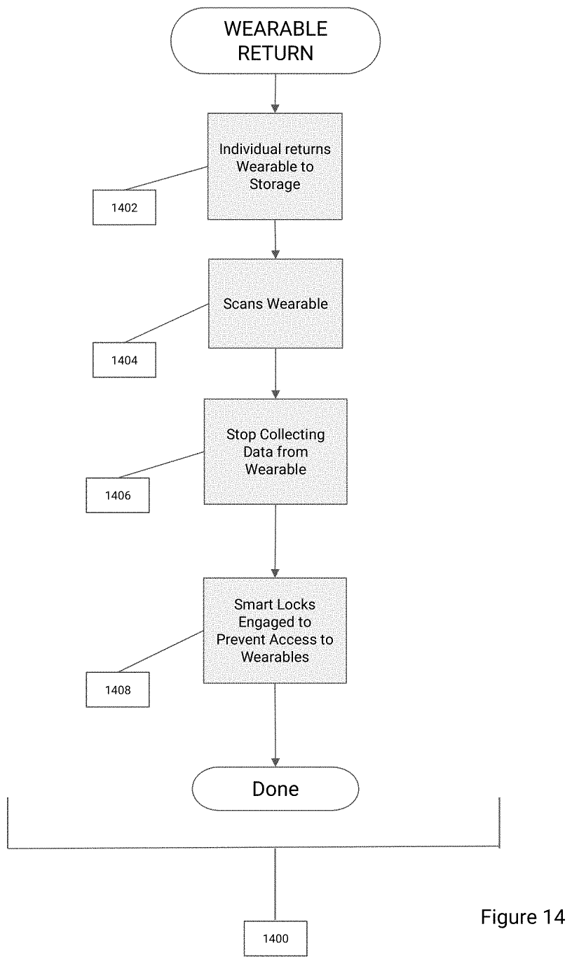

Once individuals at the construction site are finished with their assigned tasks, they may be required to return the wearables. FIG. 14 is a flowchart 1400 illustrating the steps that may be performed to return such wearables. In particular, the individual returns the wearable to the storage location 1402. The individual then scans the wearable to indicate that the individual is no longer wearing the wearable 1404. The site supervisor system may then stop collecting data from the wearable 1406. After a sufficient period of time, the smart lock may be engaged to prevent access to the wearable by the individual 1408.

As was discussed above, the site supervisor system may control access to electrical power at the construction site. This may be a significant issue in conventional construction sites where a great deal of power may be used by parties without paying for the power or parties may use power during non-working hours.

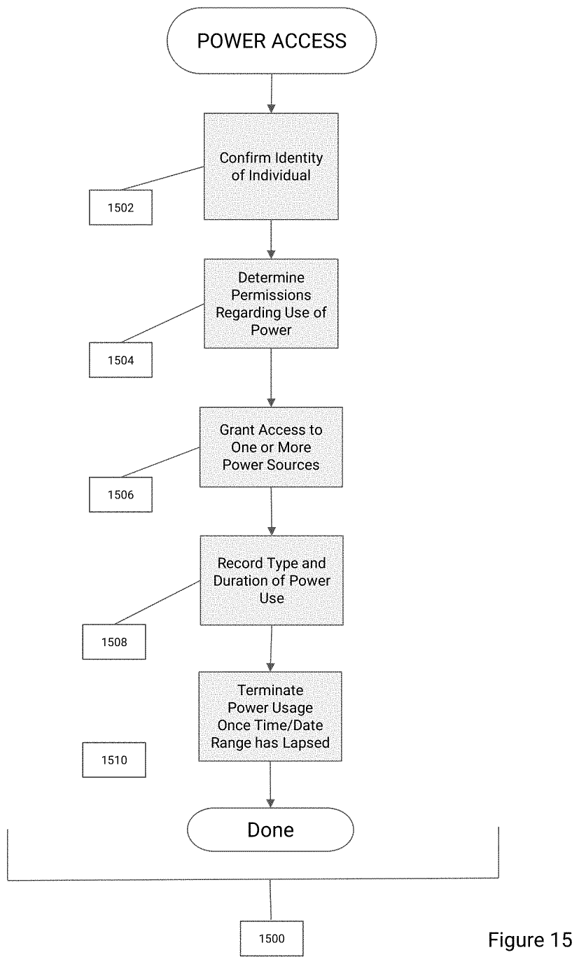

FIG. 15 shows a flowchart 1500 of steps that are performed to regulate power access by the site supervisor system at a construction site. Initially, the system confirms the identity of the individual as has been discussed above 1502. Permissions are accessed to determine the permissions relating to the use of power that are granted to the individual 1504. In the case where the individual has sufficient permissions, access to one or more power sources is granted 1506. The kiosk may include switches or other mechanisms for turning power on or off under programmatic control. The system records the type and duration of power use 1508. The power outlets may provide power at different voltages, and this information is recorded along with the duration and quantity of power that is consumed. Once the time/date range has lapsed, power usage to the individual is terminated 1510. In some instances, the power usage may be terminated after a given period of time has elapsed in which the power has not been utilized.

As was mentioned above, the wearables provide biometric data regarding individuals of the construction site. The site supervisor system may monitor this information and prompt action under certain circumstances.

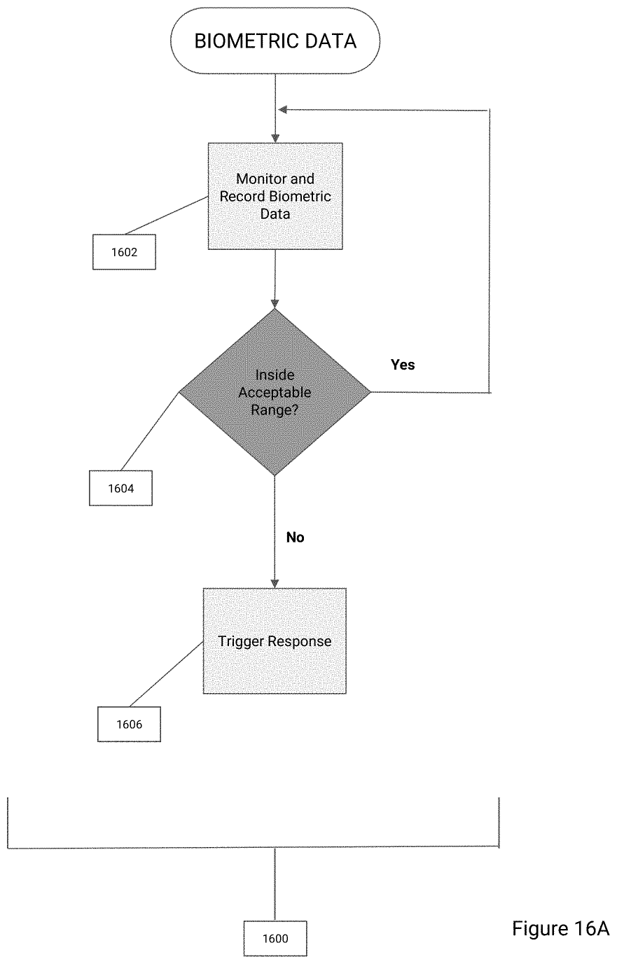

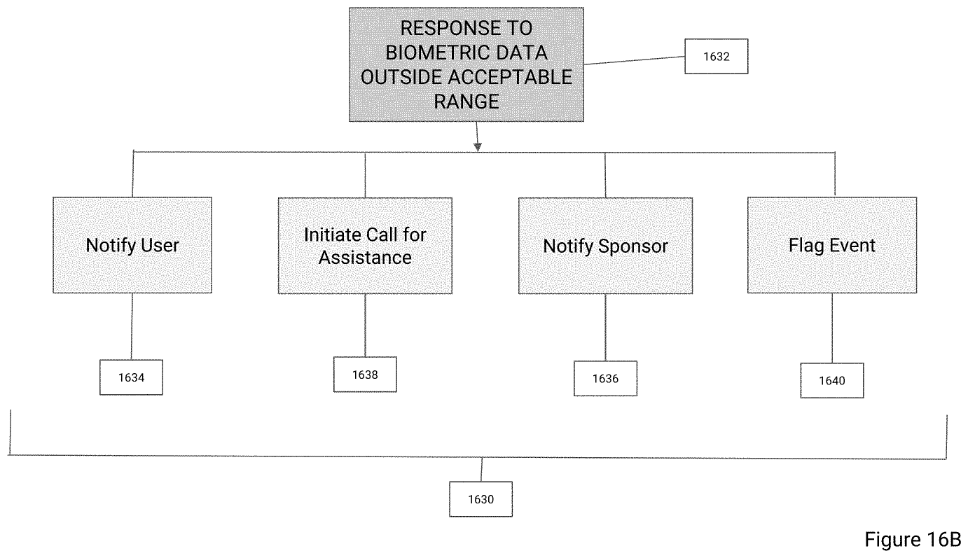

FIG. 16A provides a flowchart 1600 of steps that may be performed relative to the monitoring of such biometric data. The biometric data for each of the individuals on the construction site that are wearing wearables is monitored and recorded 1602. The system may check to see whether the biometric data is outside of acceptable ranges. For example, suppose that the biometric data indicates that the heart rate of an individual has exceeded 200 beats per minute or that the heartrate of an individual has dropped to a dangerously low rate. This would be the type of event that would trigger a response. Other suitable types of events include if the body temperature of the individual becomes excessive or too low. Similarly, blood pressure readings may be gathered and compared to acceptable ranges. Breathing rates may be monitored as well. It is determined whether the most recent rating is outside of an acceptable range 1604. If it is, a response may be triggered 1606.

FIG. 16B shows an example of some types of responses may be triggered in diagram 1630. When a monitored biometric data is outside an acceptable range 1632, one option is to notify the wearer of the wearable that the biometric data is outside a range 1634. For instance, a party might be notified that their heart rate is too high or that their body temperature is too high. The individual should take a break, sit in the shade, and/or drink some water, or take other appropriate action. The response may also include flagging an event in the stored data 1640. This is a way of flagging abnormalities where the data is outside the acceptable range and may be used as a reference point for later investigation. A further option is to notify a supervisor 1636. This may inform the supervisor that an event has happened or that an individual is at risk. Moreover, the information may indicate to a supervisor that the individual is not working. A further option is to initiate a call for assistance, such as calling an ambulance or contacting law enforcement officials 1638.

As was mentioned above, the site supervisor system, enables tracking of equipment, tools and materials at the construction site.

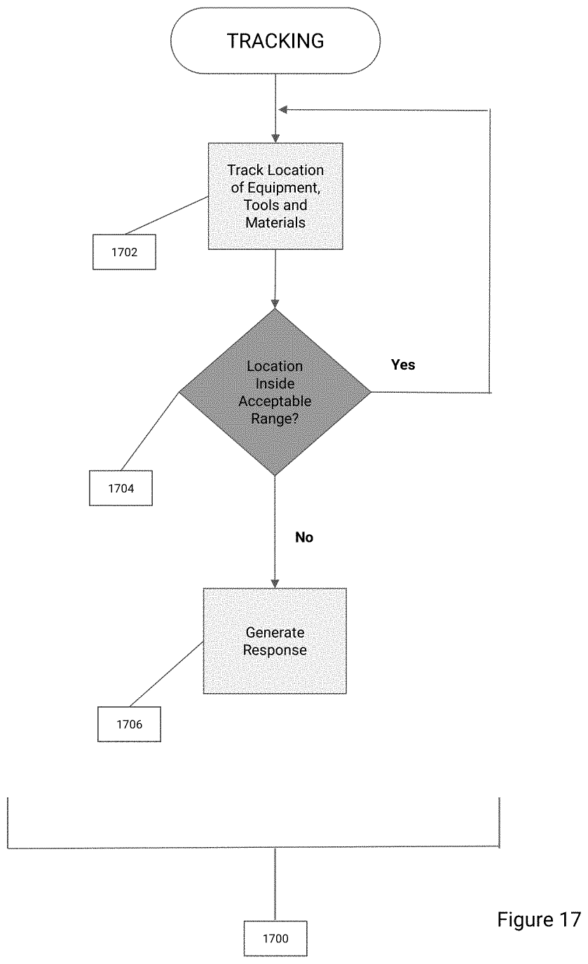

FIG. 17 shows a flowchart of steps that may be performed relative to such tracking. On an ongoing basis, the site supervisor system may track the location of equipment, tools or materials at the construction site 1702. The system can check whether the location of the equipment, tools or materials is acceptable or not 1704. For example, suppose that lumber has been delivered to the construction site and the location of the lumber indicates that the lumber is removed from the construction site. This would be problematic and would warrant a response. If the location is not acceptable as checked in 1704, a response is generated in 1706.

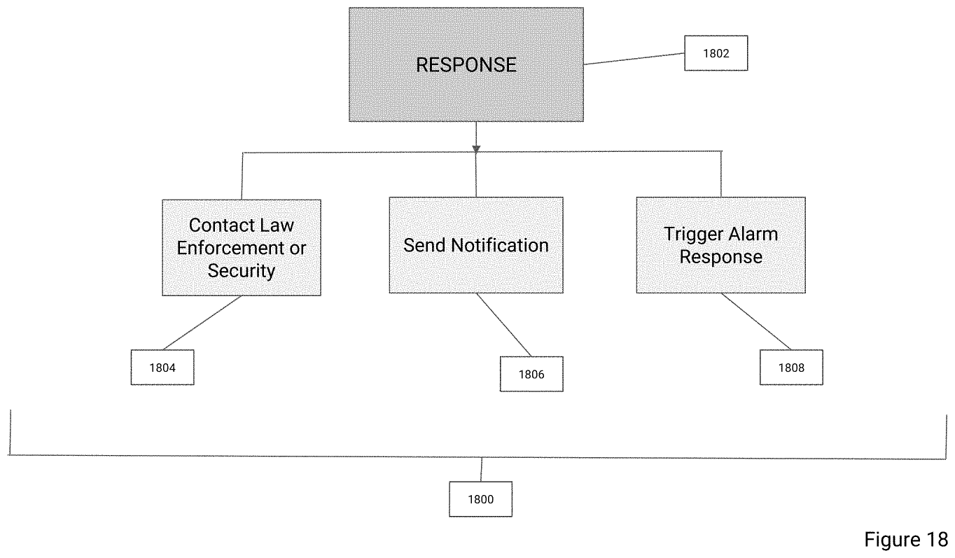

FIG. 18 shows a diagram 1800 illustrating different types of responses 1802 that may be generated in response to the equipment, tools or material in an unacceptable location. One response is to contact law enforcement or security 1804. In many cases the location of the tools, equipment and materials may indicate that a theft is underway. Another response is to send a notification to supervisor or to other appropriate parties at the construction site 1806. A final response is to trigger an alarm response 1808, such as the sounding of an audio alarm or a video alarm.

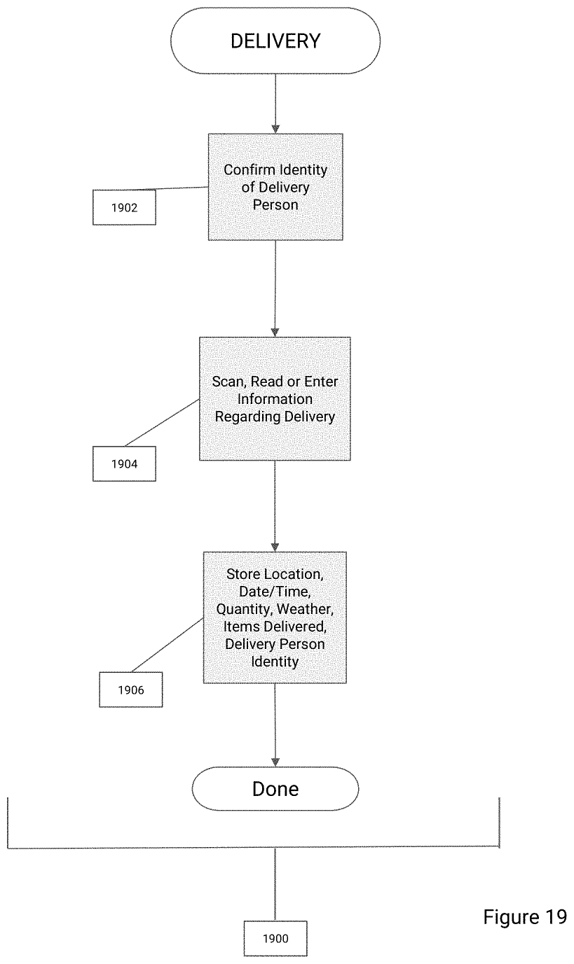

As was mentioned above, the site supervisor system helps monitor and control deliveries to the construction site. FIG. 19 depicts a flowchart 1900 showing steps that may be performed in this regard regarding deliveries. Initially, the identity of the delivery person is confirmed to indicate that the delivery person is the appropriate party and is permitted access to the construction site 1902. For example, a serial number or other identification indicator may be scanned or read off the delivered items. In addition, information may be entered by the delivery person using the kiosk, such as by entering information via touchscreen 106A (FIG. 1A) 1904. The location of delivery, the date of delivery, the time of the delivery, the quantity of delivery, the identity of the delivery person and the weather may be recorded as part of the information that is kept regarding the delivery. This information may later be used to track and confirm deliveries as well as to understand the conditions when the delivery was made.

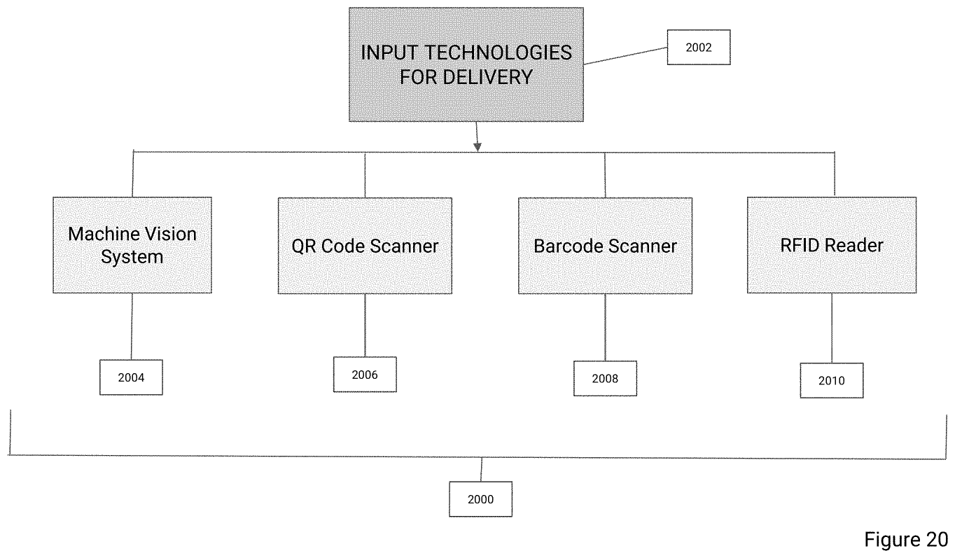

As was discussed above, the deliveries may utilize various scanning and reader technology. In FIG. 1A, a scanner 110A may be provided. Diagram 2000 in FIG. 20 illustrates different types of input technologies 2002 that may be used for assisting gathering information regarding deliveries. A machine vision system 2004 may be provided. The machine vision system 2004 may capture an image of the delivered items and process the image to determine the nature of the items that were delivered as well as the quantity of items. Moreover, the machine vision system may capture an archival image that may be indicative of the state of the items when they were delivered. A QR code scanner 2006 may be used where QR codes are on a delivered items or documentation. Similarly, a bar code scanner 2008 may be used where bar codes are on the items or on documentation delivered with the items. Still further, an RFID reader 2010 may be provided to gather information regarding the delivered items.

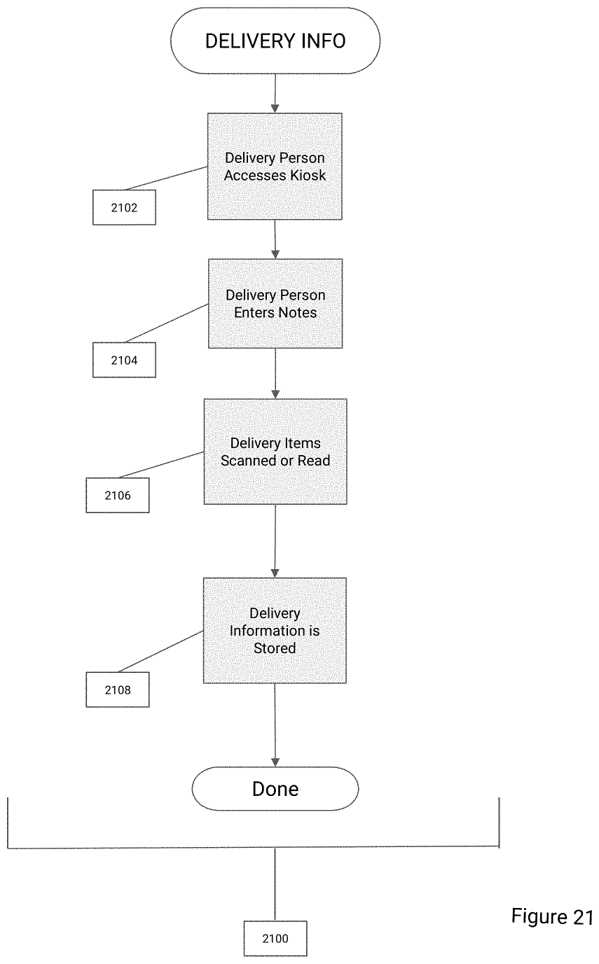

As mentioned above, the delivery person may interface with kiosk via touchscreen 106A and 1900 to provide delivery information. Flowchart 2100 of FIG. 21 illustrates some of the steps that may be performed in such an instance. Initially, the delivery person may access the kiosk 2102. The delivery person may enter a note(s) regarding the delivery, such as what was delivered and the state of items that were delivered 2104. This information may be entered, such as through the touchscreen 106A (FIG. 1A). The delivered items are imaged, scanned or read 2106. As was mentioned above, a number of different types of input technology may be used on the delivered items. The result is that delivery information is then stored in records that may be accessed subsequently 2108.

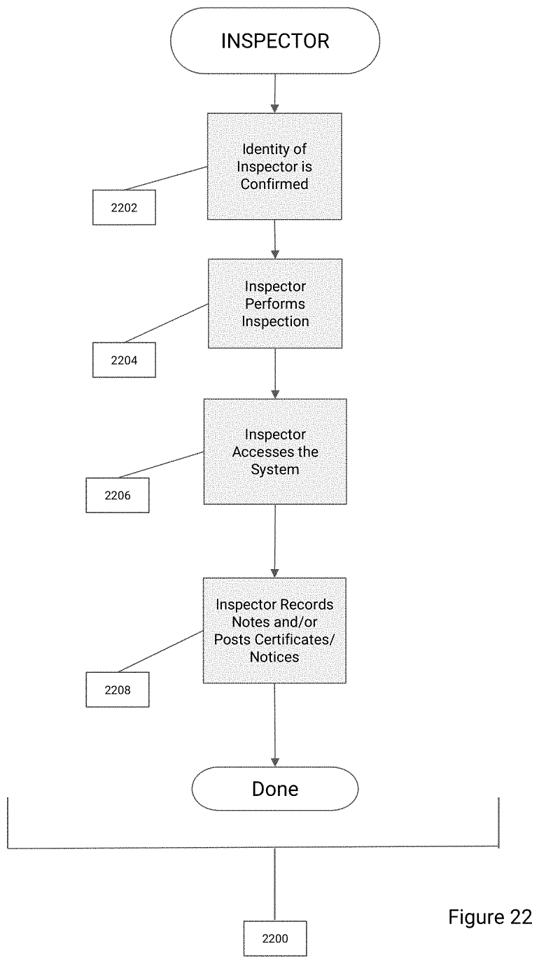

The inspector may interface with the site supervisor system. FIG. 22 includes a flowchart 2200 illustrating steps that may be performed in such an interaction. Initially, the identity of the inspector may be confirmed using the biometric data 2202 or manually using the touchscreen on the kiosk. The inspector then performs the inspection of the appropriate portion of the construction site 2204. The inspector then accesses the system, such as through the kiosk 2006. The inspector then may record notes and/or post certificates or notices at the kiosk 2208. Additionally, the inspector may use technology available via the kiosk such as OCR scanner or the like to capture appropriate information the inspector may have written during fulfillment of the reason for being on the site.

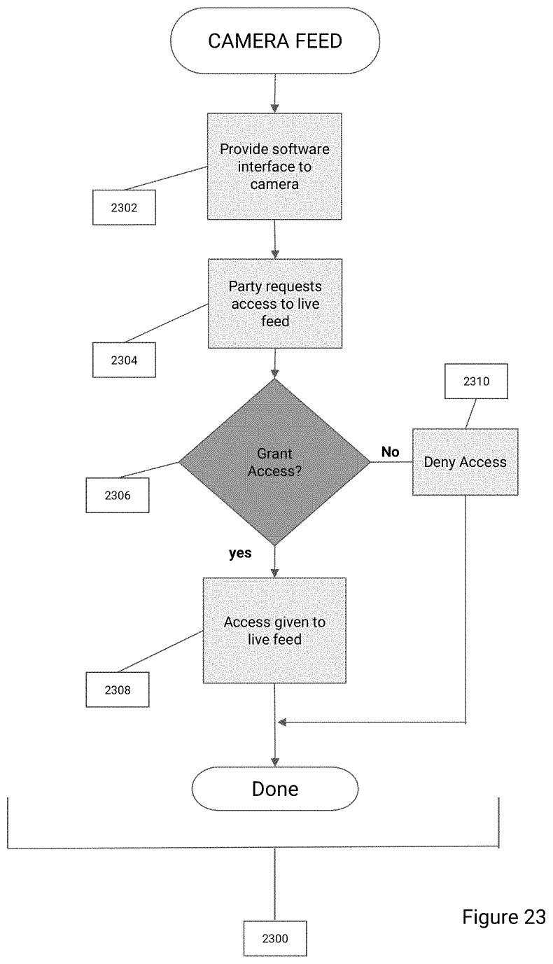

The site supervisor system may include a still camera(s) or a video camera(s) that is part of the system. FIG. 23 provides a flowchart 2300 relating to such access. A software interface to the camera may be provided to enable authorized external parties to gain access to the camera 2302. A party requests access to the camera via the interface over the network 2304. For example, a bank official may wish to view the construction site before authorizing release of funds or before granting a loan. A determination is made whether the party is permitted access 2306. If the party is permitted access, access is given to the party so that they may receive a captured image or video data 2308. Otherwise, access to the camera by the party is denied 2310.

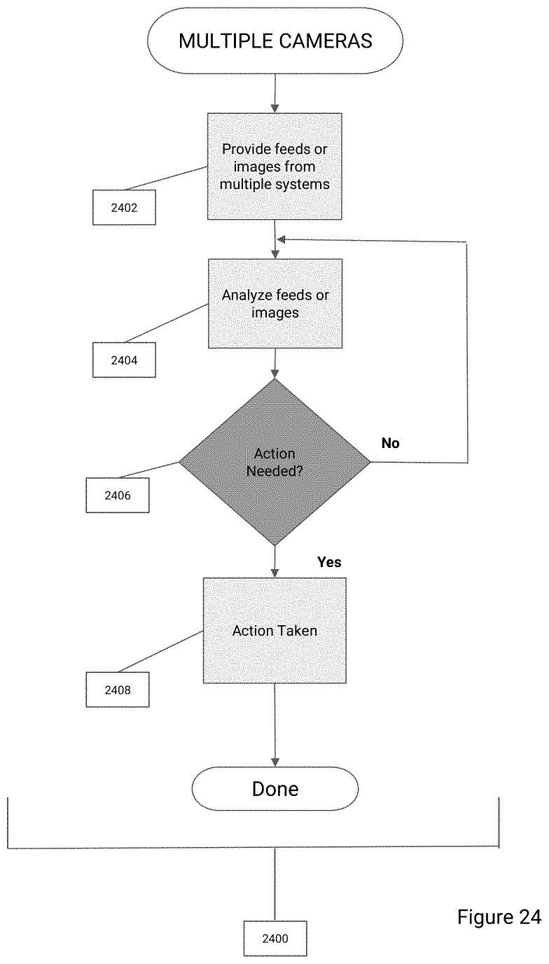

Site supervisor systems at adjacent locations may be used in conjunction with each other. FIG. 24 shows a flowchart 2400 of steps that may be performed when image capture devices, such as still cameras or video cameras, from multiple adjacently situated site supervisor systems are used in conjunction in one example application. In particular, video feeds or still images may be obtained from the image capture devices from multiple systems 2402. The video feeds or images may then be processed, such as by the cluster described above, using software such as motion detection software, thermal image analysis or other image analysis software to identify activity that may warrant a response 2404. For example, the analysis may identify a large living object moving near the periphery of multiple construction sites. The system may then, based on the analysis, determine if action needs to be taken 2406. If an action is needed, then the action is taken 2408. If not, the capture of the images or videos may continue. Examples of actions include sounding an alarm, contacting law enforcement, contacting a security team or the like.

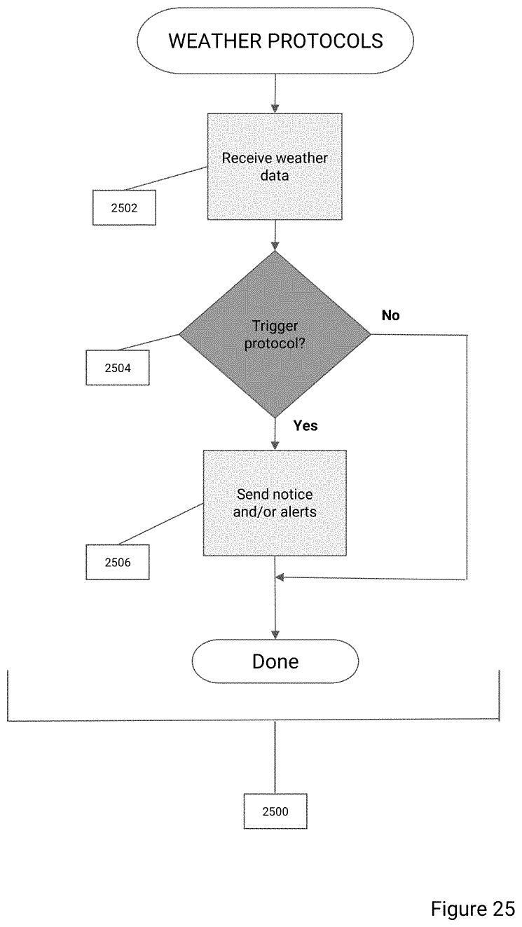

The weather conditions may trigger a number of different protocols that are performed by the system. For example, inclement weather, very cold weather or very hot weather may trigger protocols to ensure worker safety and productivity as well as the protection of structures and equipment at the construction site. FIG. 25 shows a flowchart 2500 of steps that relate to such protocols. Initially, the site supervisor system receives weather data 2502. A check is made whether the weather data values trigger any protocols 2504. If a protocol is triggered, notices and alerts may be sent as part of the protocol to the appropriate parties 2506. For example, if the temperature is over 90 degrees farenheit, a party may be sent a notice to take a break every hour and to get a drink. Related notices may be sent to supervisors. As another example, if it is too cold, workers may be prompted to wear gloves and hats and to spend time in a heated space every hour. In still another example, if severe weather is approaching, workers may be prompted to secure the construction site and seek a safe location. In a final example, workers may be prompted not to take actions, such as pouring concrete, applying paint or applying stucco, in certain weather conditions.

While the present invention has been described with reference to exemplary embodiments herein, those skilled in the art will note that various changes in form and detail may be made without departing from the intended scope of the present invention as defined in the appended claims.

What is claimed as new and desired to be protected by Letters Patent of the United States is:

1. A site supervisor system for use at a construction site, comprising
a biometric-based identification device for capturing a biometric data from an individual;
processing logic configured for:
analyzing the biometric data of the individual to determine the identity of the individual;
based on the analyzing,
determining that the individual is permitted access to at least a portion of the construction site; or
determining that the individual is not permitted access to at least a portion of the construction site and at least one of triggering an alarm and/or sending a notification to a predetermined party; and
a storage for storing information and/or computer program instructions.

2. The site supervisor system of claim 1, further comprising at least one location tracking device for receiving location information regarding a position of the individual on the construction site.

3. The site supervisor system of claim 2, wherein the at least one location tracking device is configured to receive information regarding locations of additional individuals on the construction site.

4. The site supervisor system of claim 2, wherein the at least one location tracking device is at least one Global Positioning System (GPS) device.

5. The site supervisor system of claim 2, wherein the at least one location tracking device tracks a location of one or more materials at the construction site.

6. The site supervisor system of claim 5, wherein the processing logic uses information gathered from the at least one location tracking device to confirm what individuals and what materials are on the construction site.

7. The site supervisor system of claim 2, wherein the storage stores the information regarding the position of the individual on the construction site over time.

8. The site supervisor system of claim 3, wherein the storage stores the information regarding the locations of additional individuals on the construction site over time.

9. The site supervisor system of claim 3, wherein the processing logic is configured for generating a user interface that shows the locations of the individual and the additional individuals on the construction site.

10. The site supervisor system of claim 2, wherein the processing logic is configured for performing geofencing for the construction site.

11. The site supervisor system of claim 10, wherein the processing logic generates an alert when the individual is in a prohibited area as defined by the geofencing.

12. The site supervisor system of claim 2, wherein the storage further stores permissions regarding the construction site granted to the individual.

13. The site supervisor system of claim 12, wherein the processing logic is further configured for accessing the permissions and for reviewing the GPS information to determine whether to grant access to at least one of tools, equipment, power or areas at the construction site.

14. The site supervisor system of claim 13, wherein the processing logic controls at least one smart lock to grant or deny access to at least one of the tools, equipment or areas at the construction site.

15. The site supervisor system of claim 13, wherein the processing logic examines a current time and/or date in determining whether to grant access to at least one of tools, equipment, power or areas at the construction site.

16. The site supervisor system of claim 1, wherein the processing logic in determining that the individual is permitted access or in determining that the individual is not permitted access also compares a current time to a time range in which the individual is granted access to at least a portion of the construction site.

17. The site supervisor system of claim 1, further comprising a computing device including a display and an input mechanism for providing input to the computing device.

18. The site supervisor system of claim 17, wherein the display is a touch screen display.

19. The site supervisor system of claim 1, further comprising power outlets for providing power.

20. The site supervisor system of claim 19, further comprising a control mechanism for controlling access to at least one additional utility other than power.

21. The site supervisor system of claim 1, wherein the processing logic monitors and records power usage via the power outlets in the storage.

22. The site supervisor system of claim 1, further comprising technology for sensing or scanning delivery of items to the construction site.

23. The site supervisor system of claim 22, wherein the processing logic is configured to confirm delivery of items at a designated location.

24. The site supervisor system of claim 1, wherein the technology is one of a Radio Frequency Identification (RFID) detector, ultra-high frequency (UHF) detector, a bar code scanner, a QR code scanner, Near Frequency Communication (NFC) device or an optical character recognition (OCR) device.

25. The site supervisor system of claim 1, wherein the system is contained in a kiosk.

26. The site supervisor system of claim 1, further comprising a weather station and/or interface for collecting and providing weather information.

27. The site supervisor system of claim 1 further comprising a battery, solar or wind power source.

28. The site supervisor system of claim 1, further comprising an interface for enabling an inspector to enter information regarding an inspection that is stored by the site supervisor system.

29. The site supervisor system of claim 1, further comprising an interface for enabling a delivery person to enter delivery information that is stored by the site supervisor system.

30. The site supervisor system of claim 1 wherein the processing logic is configured to gather worker's compensation information and report any resulting worker's compensation claim.

31. The site supervisor system of claim 30, wherein a video conference to a designated party is initiated by the processing logic to gather the worker's compensation information and report any resulting worker's compensation claim.

32. The site supervisor system of claim 1, wherein the processing logic is configured to gather information regarding an injury at the construction site and to report the injury to a designated party.

33. The site supervisor system of claim 32, wherein a video conference is initiated by the processing logic to gather the information regarding the injury and to report the injury.

34. The site supervisor system of claim 1, further comprising a display for displaying information for treating an injury.

35. The site supervisor system of claim 1, further comprising a display for displaying information regarding handling of hazardous materials.

36. The site supervisor system of claim 1, wherein the processing logic is configured to provide a user interface for reporting any injuries or an absence of injuries for a time period.

37. The site supervisor system of claim 1, wherein the system includes a camera and the processing logic enables an external party remote from the construction site to view a live feed from the camera.

38. The site supervisor system of claim 1, where the biometric based identification device is one of a facial recognition device, a fingerprint-based recognition device, a retinal scanner, a voice print recognition device or a hand scanning recognition device.

39. The site supervisor system of claim 1, wherein current weather conditions are consulted in granting or denying access to the individual to the construction site.

40. The site supervisor system of claim 1, wherein current weather conditions are recorded along with a current sequence of construction at the construction site.

41. A site supervisor system for use at a construction site, comprising:
sensing technology for sensing at least one item being brought to the construction site;
a storage device; and
processing logic for processing information sensed by the sensing technology to identify an identity of the at least one item and a quantity of the at least one item and for storing information regarding the identity and the quantity of the at least one item in the storage device.

42. The site supervisor system of claim 41, further comprising tracking technology for tracking a location of the at least one item at the construction site.

43. The site supervisor system of claim 42, wherein the tracking technology is a global positioning system (GPS) based technology, a radio frequency identification (RFID) technology, Near Frequency Communication (NFC) device and/or a beacon-based technology.

44. The site supervisor system of claim 41, wherein the sensing technology additionally is for sensing at least one item being removed from the construction site.

45. The site supervisor system of claim 44, wherein the processing logic processes information sensed by the sensing technology to identify the at least one item being removed from the construction site and a quantity of the at least one item being removed and stores the identity and the quantity of at least one item being removed in the storage device.

46. The site supervisor system of claim 41, wherein the sensing technology includes at least one of a bar code reader, a QR code reader, a radio frequency identification (RFID) reader or a machine vision system.

47. The site supervisor system of claim 41, wherein the system is in a kiosk.

48. A method performed by a site supervisor system at a construction site, wherein the site supervisor system includes an image capture device, processing logic and a storage device, the method comprising:
capturing an image of an individual at the construction site with the image capture device;
with the processing logic performing facial recognition on the image of the individual to attempt to identify the individual;
where the facial recognition fails to identify the individual, denying access to the construction site; and
where the facial recognition identifies the individual, based at least in part on the determined identity, granting access or denying access to the construction site.

49. The method of claim 48, wherein permission information for the individual is stored in the storage device and wherein the permission information is accessed in granting access or denying access to the individual.

50. The method of claim 48, wherein the permission information includes time and date information for which the individual is granted access to the construction site and wherein the granting or denying is based in part on a current date and time.

51. The method of claim 48, wherein the current weather conditions are recorded along with a current sequence of construction at the construction site.

52. The method of claim 48, further comprising:
with the processing logic performing geofencing such that the individual is granted access to an area of the construction site but not to another area of the construction site.

53. A method performed by a site supervisor system at a construction site, wherein the site supervisor system comprises a biometric-based identification device for identifying an individual based on biometric data, a storage device for storing permission information and processing logic, the method comprising:
obtaining biometric data from the individual via the biometric-based identification device;
processing the biometric data with the processing logic to attempt to determine the identity of the individual;
where the identity of the individual is determined and the permission information indicates that the individual is entitled to access, controlling at least one smart lock to grant access to at least one of a tool, a piece of equipment or an area of the construction site; and
where the identity of the individual is not determined or where the permission information indicates that the individual is not to be granted access, controlling at least one smart lock to deny access to at least one of a tool, a piece of equipment or an area of the construction site.

54. The method of claim 53, wherein the obtaining the biometric data comprises capturing an image of the individual and wherein the processing the biometric data comprises performing facial recognition of the image to attempt to determine the identity of the individual.

55. The method of claim 53, wherein the biometric data is one of fingerprint data, retinal scan data, voice print data, or hand scan data.

56. A method performed by a site supervisor system at a construction site, wherein the site supervisor system comprises a biometric-based identification device for identifying an individual based on biometric data, a storage device for storing permission information and processing logic, the method, comprising:
obtaining biometric data from the individual via the biometric-based identification device;
processing the biometric data with the processing logic to attempt to determine the identity of the individual;
where the identity of the individual is not determined or where the permission information indicates that the individual does not have permission, denying access to one or more power sources; and
where the identity of the individual is determined and the permission information indicates that the individual has permission to access the one or more power sources, granting access to the one or more power sources.

57. The method of claim 56, wherein the site supervisor system has at least one power plug and where granting access comprises providing power to the at least one power plug while granting physical access to the at least one power plug and where denying access comprises providing no power to the at least one power plug and/or denying physical access to the at least one power plug.

58. The method of claim 57, wherein the at least one power plug includes a first power plug providing a first voltage level and a second power plug providing a second voltage level.

59. The method of claim 58, further comprising recording in the storage device how much power is consumed and over what time period by the individual after access is granted to the one or more power sources.

60. A method performed by a site supervisor system, wherein the site supervisory system includes processing logic and a storage, the method comprising:
receiving at the site supervisor system information from a wearable worn by an individual on a residential construction site;
storing the received information in the storage;
analyzing the received information to determine whether an action needs to be taken based on the received information.

61. The method of claim 60, wherein the data is location information for the individual.

62. The method of claim 60, wherein the received information is biometric data for the individual.

63. The site supervisor system of claim 62, wherein the biometric data includes at least one of heart rate, body temperature, respiration rate or blood pressure.

64. The method of claim 60 wherein the action is one of triggering an alarm, sending a communication to wearable to trigger an alarm, or contacting a supervisor.
